(19) United States
(12) Patent Application Publication
(10) Pub. No.: US 2013/0246236 A1
(43) Pub. Date: Sep. 19, 2013

(54) MOTIVATION OF MEMBERS

(71) Applicants: Ryan K. Wuerch, Medina, WA (US); James P. Ryan, Bellevue, WA (US)

(72) Inventors: Ryan K. Wuerch, Medina, WA (US); James P. Ryan, Bellevue, WA (US)

(73) Assignee: SOLAVEI LLC, Bellevue, WA (US)

(21) Appl. No.: 13/557,919

(22) Filed: Jul. 25, 2012

Related U.S. Application Data
(63) Continuation-in-part of application No. 13/421,616, filed on Mar. 15, 2012.
Application No. 13/421,616 is a continuation-in-part of application No. 13/452,479, filed on Apr. 20, 2012.

(51) Int. Cl. G06Q 30/00

(52) U.S. Cl. 705/35

(57) ABSTRACT

Various implementations for enabling sales activity are described. A commissioning interface is caused to be displayed on a computing device. A notification regarding the compensation status of the entity is presented within the commissioning interface, and an interactive too is provided within the context of the display of the notification. The interactive tool enables the entity to initiate an action to achieve a new compensation status.

### RELATED APPLICATIONS

The present application is a continuation-in-part of U.S. application Ser. No. 13/421,616 filed on Mar. 15, 2012, and entitled “Mobile Service Distribution and Provisioning Architecture,” and a continuation-in-part of U.S. application Ser. No. 13/452,479 filed on Apr. 20, 2012, and entitled “Compensation Based on Entity Groups.” The entire contents of both of these applications are hereby incorporated herein by reference in their entirety for all purposes.

### BACKGROUND

Conventional direct sales models pay their participants based on the sales that their participants make and on the sales made by individuals within the participants' networks. Thus, a participant in a direct sales environment has an incentive not only to make sales directly, but to help individuals within his or her network make sales. The participant also has an incentive to find additional participants, because the larger his or her network, the more sales that are attributable to the participant, thereby increasing his or her income. Thus, a direct sales participant who takes care to monitor his or her network for the best performers can take proactive steps to assist those best performers and make more money. Also, the better the participant understands the commissioning model, the more easily the participant is able to spot opportunities to increase their own revenue.

### BRIEF SUMMARY

A commissioning interface provides notifications regarding an entity's compensation status, such as the number of members within their network or the number of entity groups that the entity needs to obtain to advance to a new compensation tier. Within the context of the notification, the commissioning interface displays an interactive tool that enables the entity to initiate an action to advance to a new compensation status. The notification type and the interactive tool may be selected based on a current compensation status, such as whether the entity is in a particular commissioning phase.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of an example system for acquisition of new members using mobile device tools.

FIG. 2 is a schematic diagram of an example system for acquisition of new members using social media tools.

FIG. 3 illustrates an example environment for providing commissions based at least in part on purchases made at participating retailers.

FIG. 4 illustrates an example environment for enabling sales activity using a motivation platform.

FIG. 5 illustrates an example relationship network during a first phase of an example revenue sharing model.

FIG. 6 illustrates an example relationship network during a second phase of an example revenue sharing model.

FIG. 7 illustrates an example relationship network during a third phase of an example revenue sharing model.

FIG. 8 illustrates an example commissioning interface that includes notification placeholders and interactive tools for enabling sales activity.

FIGS. 9A-9D illustrate example notifications and interactive tools displayed within notification placeholders within a commissioning interface.

FIG. 10 illustrates a social networking tool that enables entities to initiate action to achieve a new compensation status.

FIG. 11 illustrates an example commissioning interface that enables an entity to track sales activity.

FIG. 12 illustrates an example commissioning interface that enables an entity to identify members of their relationship networks that are close to achieving new compensations statuses.

FIGS. 13-16 illustrate example commissioning interfaces with notifications and interactive tools for display on mobile devices.

FIG. 17 illustrates an example commissioning interface showing status of a competition.

FIG. 18 is a block diagram of an example computing system usable to provide a transaction service.

FIG. 19 is a flow diagram showing an example process for providing notifications and interactive tools that enable sales activity.

### DETAILED DESCRIPTION

### Overview

Embodiments of the present disclosure include a transaction service that includes a motivation platform to provide notifications and interactive tools to enable sales activity. As noted above, participants within a sales model who are able to track their status and the status of the entities within their relationship networks can identify opportunities for increasing their revenue and building their networks. Embodiments provide a commissioning interface that provides notifications regarding an entity's compensation status, such as the number of members within their network or the number of entity groups that the entity needs to obtain to advance to a new compensation tier. Within the context of the notification, the commissioning interface displays an interactive tool that enables the entity to initiate an action to advance to a new compensation status. The notification type and the interactive tool may be selected based on a current compensation status, such as whether the entity is in a particular commissioning phase.

By providing a member with information regarding their compensation status and the state of their relationship network, and by providing the entity with interactive tools within the context of the display of the information, embodiments allow entities to keep track of their compensation status and to take action to achieve or advance towards a new compensation status. Embodiments enable members to interact with other members, in order to encourage or to assist those other members, and to take action to invite new members. Embodiments also foster competition between members, such as by prominently displaying other members' ranks and through competitions, such as a top performer bonus challenge. Intelligently supplied information to the member regarding his or her compensation status, tools to enable actions (including member interactions), and competitive aspects of embodiments combine together to motivate members to take action and drive revenue. Embodiments reduce the effort required on the part of the entity to determine the actions that he or she needs to take to advance to a new compensation level as well as the effort required on behalf of the entity to actually take the action. Furthermore, by providing members with the opportunity and tools to interact with other members, and by supplying intelligence to the members, members are motivated and inspired not only to assist one another, but also to achieve or outdo the results achieved by other members. Embodiments thus provide tools for action and intelligently supplied information while fostering both a competitive and a cooperative environment. Embodiments thereby leverage individuals' social interactions, within a competitive and cooperative environment, to motivate individuals to take action and engage with others for the purpose of making money or other compensation. The result is increased revenue and relationship network growth for the member, and an increase in overall sales activity.

The processes, systems, and devices described herein may be implemented in a number of ways. Example implementations are provided below with reference to the following figures.

Next, an example direct sales model related to mobile service will be described. Embodiments are not limited to this direct sales model. Later, example revenue sharing models based at least in part on network size and compensation tiers will be described. Finally, various commissioning interfaces will be described to provide motivation to members and interactive tools to enable members to initiate actions to achieve a new compensation status.

### Example Environments for New Member Acquisition

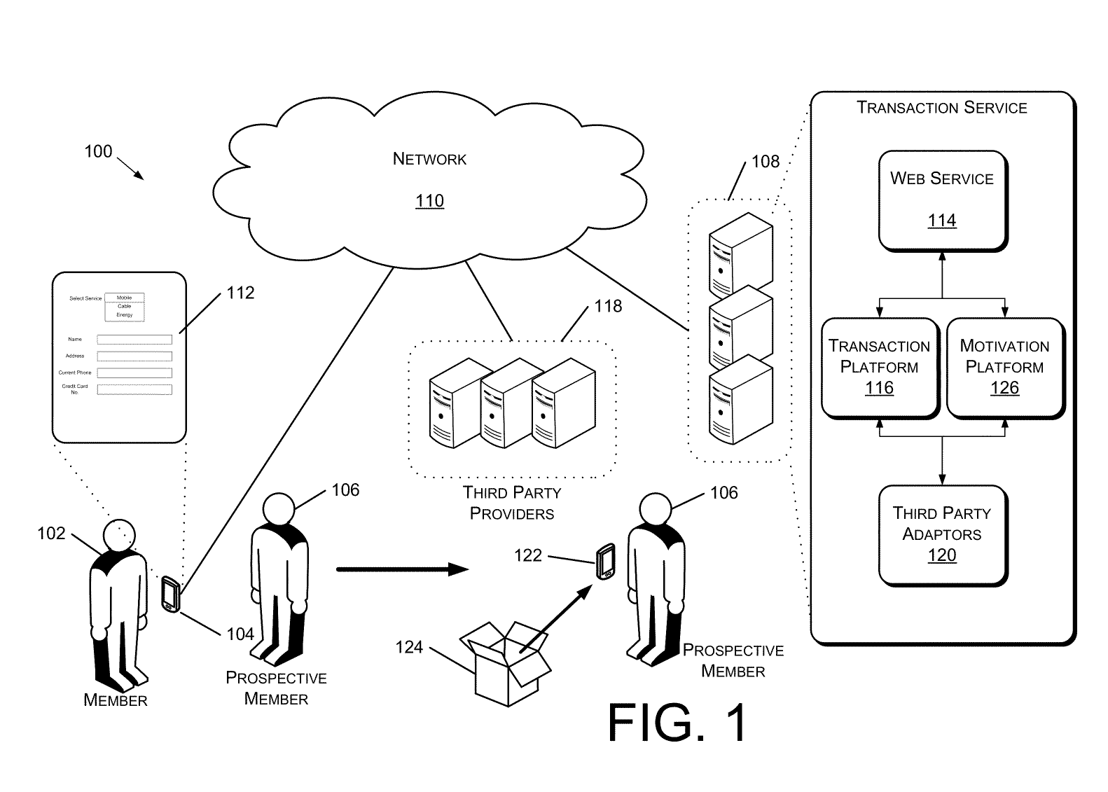

FIG. 1 is a schematic diagram of an example system 100 for acquisition of new members using mobile device tools. Aspects of the system 100 may be implemented on various suitable computing device types. Suitable computing device or devices may include, or be part of, one or more personal computers, servers, server farms, datacenters, special purpose computers, tablet computers, game consoles, smartphones, media players, combinations of these, or any other computing device(s).

Member 102 is a mobile service subscriber and he or she accesses a mobile service using a mobile device 104. During interaction with a prospective member 106, the member 102 is able to use the mobile device 104 to access transaction service 108 via a network 110. The member 102 interacts with a user interface on mobile device 104 to launch one or more transaction screens, such as transaction screen 112, which enable the prospective member 106 to sign up for new service and to become a member.

The one or more transaction screens provide input fields for the member 102 and/or the prospective member 106 to input the prospective member's information to sign up for the service. Through the one or more transaction screens, the prospective member 106 and/or the member 102 selects a desired handset make and model, enters in existing mobile service information, enters in their address and credit card information, and so forth. The prospective member 106 also selects phone delivery methods, and provides other information to customize their new service and to facilitate signing up for new service. The mobile device 104 may include a camera or other scanner for imaging or otherwise scanning the prospective member's credit card. In embodiments, mobile device 104 may be equipped with Bluetooth or other short-range wireless capability in order to serve up the transaction screens directly to the prospective member's 106 existing mobile device so that the prospective member 106 can enter the information directly into their own existing device.

In one embodiment, the mobile device 104 accesses a web service 114 via an installed browser and a soft link on a user interface screen of the mobile device 104. In these embodiments, the one or more transactions screens are served by the web service 114, and the prospective member's information is provided to the transaction service 108 via the web service 114 and the network 110. One or more transaction screens may be cached or stored locally on the mobile device 104 to enable the browser to access them directly rather than via the web service 114.

In another embodiment, the mobile device 104 includes an installed application that accesses the transaction platform 116 directly, or through the web service 114. The installed application may present the one or more transaction screens and transmit the prospective member's information to the transaction service 108 via the network 110. Alternatively, the installed application may download the transactions screens, or portions of the transaction screens, from the web service 114 or other portion of the transaction service 108.

A transaction platform 116 creates a new member account for the prospective member 106 in a secure member database. The transaction platform 116 associates the new member account or service with the member's 102 existing account or service, thereby adding to a relationship network for the member 102. The new member account or service may also be associated with other members' accounts or services in whose relationship networks member 102 is a member. These other accounts or services may include an account or service of a member who signed up the member 102 and accounts or services of other members above the member who signed up the member 102. Based at least in part on these associations, the transaction platform 116 is enabled to provide member 102, as well as other associated members, with benefits—such as commissions—for signing up the prospective member 106.

The transaction platform 116 interacts with one or more third party providers 118 via various corresponding third party adaptors 120. The third party providers may include, among other things, a commissioning provider, a fulfillment provider, a bank provider, a social networking provider, and so forth. The third party providers 118 carry out various functions on behalf of the transaction service 108.

In one example, a fulfillment provider may be instructed by the transaction platform 116 to ship a new mobile device 122 to prospective member 106. In this illustration, the new mobile device 122 arrives in a box 124, although in other implementations, the new mobile device may be delivered to the prospective member 106 in other ways. The prospective member 106 activates the new mobile device 122 and begins using the mobile service. The prospective member 106 may opt-in during the activation process or at some other time to use his or her existing social networking services to seek out new members. New mobile device 122 comes pre-configured with the same or similar member acquisition tools as are on the mobile device 104. Thus, the prospective member 106 is also enabled to seek out and sign up additional members.

The prospective member may also have the option to receive a Subscriber Identity Module (SIM) card in lieu of a new mobile device, such as where the prospective member's existing mobile device is compatible with the mobile service. Upon receipt of the SIM card, the prospective member can swap out their old SIM card for the new SIM card and activate their new service using their existing mobile phone.

The network 110 may include one or more wired and/or wireless networks such as the public Internet, local area networks, wide area networks, mobile carrier networks, personal area networks (PAN), and so forth. The mobile device 104 may access the network 110 using various technologies such as through Bluetooth® or other PAN technologies, Wi-Fi® technologies based on the IEEE 802.11 family of standards, Global System of Mobile Communication (GSM) standards-based technologies, code division multiple access (CDMA) mobile phone standards, and so forth. Embodiments of the present disclosure are not limited to any type or types of networking technologies or protocols.

In various embodiments, the member 102 may utilize something other than a mobile phone to access the network 110 and sign the prospective member 106 up to a new service. Thus, mobile device 104 may be a mobile phone (such as a smartphone), a tablet computer, a laptop computer, a netbook computer, a personal computer, or other device that has access to the network 110. Embodiments are not limited to particular type or types of devices for accessing the transaction service 108.

The transaction service 108 also includes motivation platform 126. The motivation platform 126 provides real-time, highly relevant alerts, messages, and reports that include data indicating activities that the member 102 may engage in to achieve additional levels of compensation or to reach other goals. Such messages are meant to motivate the member 102 to perform these activities, thereby driving additional member sign-ups and other revenue-generating activities. For example, the motivation platform 126 may determine, based at least in part on commissioning information provided by the transaction platform 116, that the member 102 may achieve a reward, commission, or other compensation by signing up a certain number of additional new members to his relationship network, by attending webinars, or by engaging in other activities. In another example, the motivation platform 126 may determine that the new member 102 may achieve a new compensation tier, thereby enabling the member 102 to receive additional compensation, by signing up a certain number of new members to his or her network.

The motivation platform 126 creates a report, social network feed, email, alert, instant message, or other communication that includes the determined information and transmits it to the member 102. This may include sending social networking messages, via the third party adaptors, to reach a social networking provider. Alternatively or in addition, the motivation platform 126 may host or be associated with a social networking service that is accessible via the web service 114. The social networking messages may include message feeds, messages, reporting screens, and so forth. By providing the user with real-time, highly relevant data, the motivation platform is able to inform the member 102 as to those activities that he or she may perform to reach their commissioning goals. Various ones of the messages, reports, and alerts may be accessible to the member 102 via a member page, such as via a social networking page that is hosted by the transaction service.

The environment of FIG. 1 depicts a real-time interaction between the member 102 and the prospective member 106. Next, social media tools for acquisition of new members will be described.

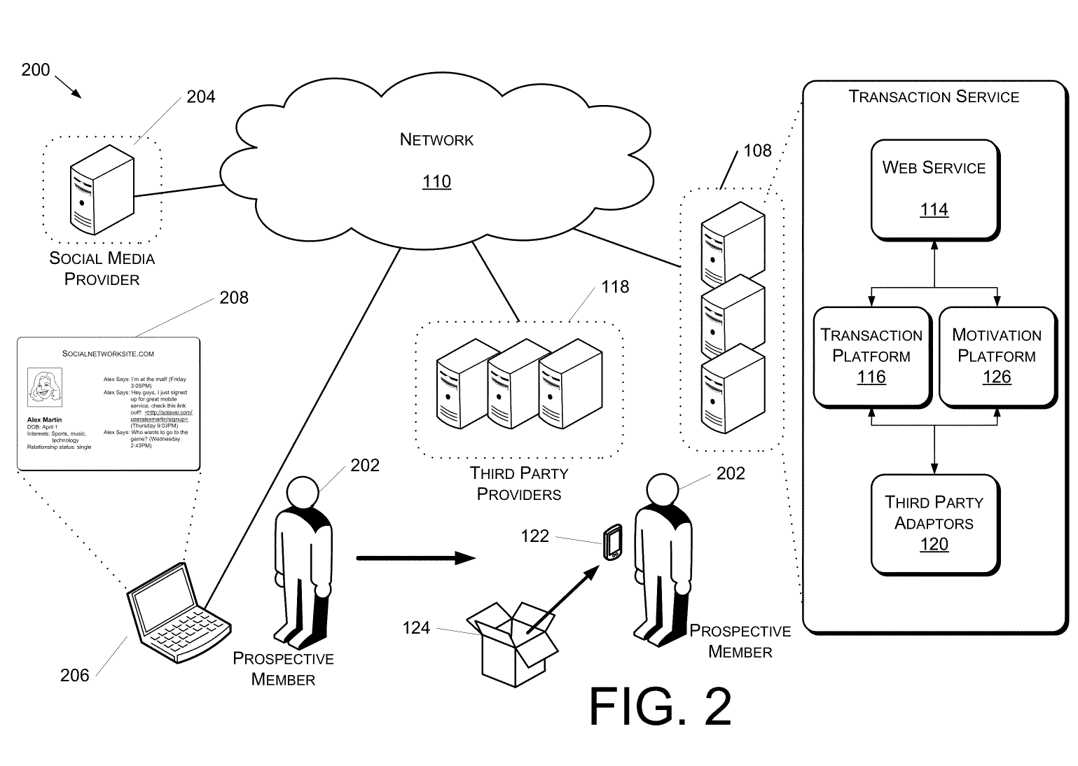

FIG. 2 is a schematic diagram of an example system 200 for acquisition of new members using social media tools. Referring to FIG. 2, a prospective member 202 accesses social media provider 204 using the personal computer 206. In embodiments, the prospective member 202 may utilize a netbook computer, a mobile phone, a tablet computer, or other device suitable for accessing the social media provider 204.

The personal computer 206 downloads social media page 208, which includes social media content. In one example, the social media page 208 is a social media page for an existing mobile service member, such as the member 102. The content on the social media page 208 includes a link to the web service 114. Clicking on the link within social media page 208 enables the prospective member 202 to browse to the web service 114 and to sign up for service through the transaction platform 116. Upon entering in their personal information and signing up for new mobile service, the prospective member 106 receives the new mobile device 122 (or a new SIM card) through a fulfillment provider of the third party providers 118 in the same or similar manner as is described with reference to FIG. 1.

The link to the web service 114 includes a resource identifier—such as universal resource identifier (URI) or a universal resource locator (URL)—that enables the personal computer 206 to access the web service 114. The link also includes embedded information that enables the transaction platform 116 to associate the existing member service with the newly created member service for the prospective member 106. This embedded information may be included as part of the URI or URL of the link. The embedded information may include some or all of the existing member's name, the existing member's phone number, the existing member's account number, a member number, or an anonymous identifier.

In this way, social media tools enable an existing member's online social media network to be leveraged for acquisition of new members. The transaction platform 116 utilizes the embedded information within social media links to associate the existing member's account or service to the new memberships that are generated through the link. The transaction platform 116 is configured to initiate bonus or commission payments for the existing member based at least in part on these associations, as is described below.

### Example Participating Retailer Environment

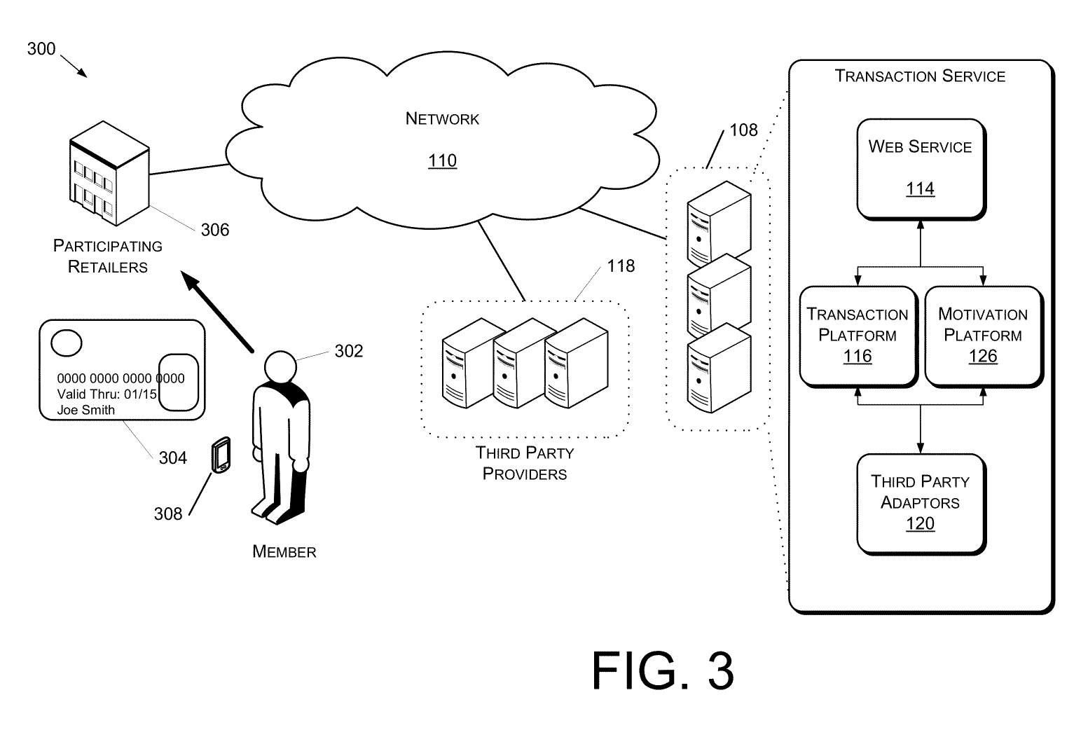

FIG. 3 illustrates an example environment 300 for providing commissions based at least in part on purchases made at participating retailers. A member 302 receives compensation for participating in a revenue sharing model according to embodiments. In embodiments, the compensation that the member receives is deposited into an account, such as may be hosted by a bank, which is one of the third party providers 118. The transaction platform 116 calculates compensation owed to the member 302 and causes it to be deposited into the account, such as for example via the third party adaptors 120. The account is associated with a transaction card 304, which may be a debit card, a credit card, member identification card, or other card type. The member 302 may utilize the transaction card 304 to make purchases at retailers that accept the transaction card 304. In alternative embodiments, the member 302 may utilize some other mechanism to correlate his or her purchases with the participating retailers 306 back to his or her member account. For example his or her mobile device (such as the mobile devices 104 and 122) may be used to make purchases. The transaction card 304 is just one mechanism to make payment at participating retailers 306. The member 302 may use the transaction card 304 instead of, or in addition to, his or her mobile phone 308 to make payments with the participating retailers 306.

Some or all of the retailers that accept the transaction card 304 for purchases may be participating retailers 306. The participating retailers 306 provide a portion of the revenue from purchases made by members at the participating retailers 306 to the transaction service 108. The participating retailers 306 may be traditional “brick and mortar” retailers, or online retailers, or have both traditional and online retail operations. Purchases made by members with the participating retailers 306 may be used to calculate additional compensation for the member 302. For example, the transaction platform 116 may calculate compensation for the member 302 based at least in part on the portion of the purchases made by the member 302 and/or the purchases made by other members that are within his or her relationship network, as is described in more detail below.

### Example Environments for Motivating Members

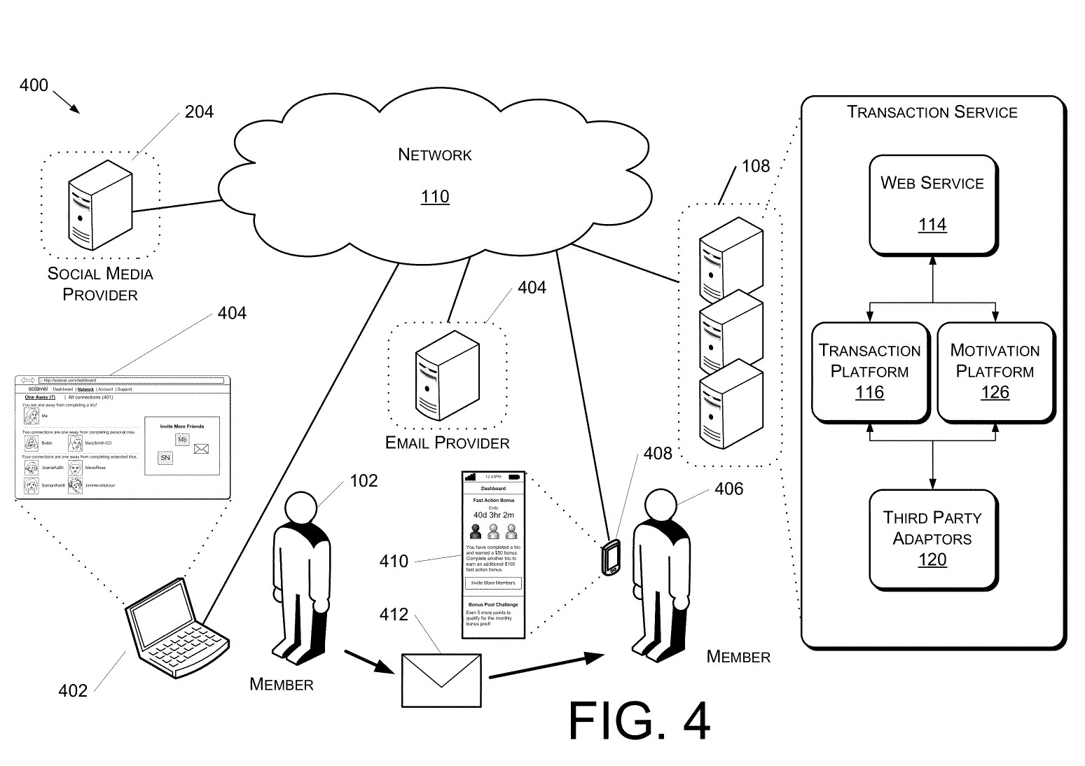

FIG. 4 illustrates an example environment 400 for enabling sales activity using a motivation platform. As noted above, motivation platform 126 provides real-time, highly relevant alerts, messages, and reports that include data indicating activities that the member 102 may engage in to achieve additional levels of compensation or to reach other goals. For example, the member 102 may utilize computing device 402 to view a commissioning interface such as commissioning interface 404. The computing device 402 may access some or all of the commissioning interface screens from the motivation platform 126 via the network 110. In embodiments, the commissioning interface may be a web interface provided by the web service 114 and/or the computing device 402. In embodiments, aspects of the commissioning interface may be provided or performed by the computing device 402.

The motivation platform 126 may access the transaction platform 116 to determine the member's 102 profile and relationship network, as well as to run through the commissioning model to determine information regarding the member's 102 compensation status. For example, the motivation platform 126 may determine the number of entities and/or entity groups within the member's 102 relationship network. The motivation platform 126 may determine an amount of money earned by the member 102, either in total, in a current compensation period (month, week, quarter, and so forth), or related to a particular activity or activities (such as selling mobile phone subscriptions or purchases made by entities at participating retailers).

The motivation platform 126 may determine one or more actions to complete for the member 102 to achieve or advance to a new compensation status. For example, the motivation platform 126 may access the commissioning model and member profile stored within the transaction platform 116 to determine that the member 102 can earn an additional $50 bonus by signing up an additional entity. Similarly, the motivation platform 126 may determine that the member 102 can achieve a new level of monthly compensation by signing up another personal entity group, and that the member can achieve another personal entity group by signing up one additional entity.

The motivation platform 126 may also determine the identities of entities within the member's 102 relationship network, such as member 406, that are within a certain range of achieving new compensations statuses of their own. For example, the motivation platform 126 may determine from the transaction platform 116 that member 406 is within the member's 102 relationship network, run what-if scenarios on the entity profiles of member 406, and determine that member 406 can sign up one additional entity to their own relationship network to achieve a new entity group. Because entity groups that entities such as member 406 within the member's 102 relationship network sign up result in an increase in the number of entity groups in the member's 102 relationship network, the member 102 has an incentive to assist those in his network sign up new members. Thus, knowing those entities within a certain range of achieving a new entity group can be very useful to the member 102.

The information regarding the member's 102 compensation status is displayed within the commissioning interface 404. The motivation platform 126 also provides an interactive tool, such as a selectable tool, within the commissioning interface 404. The interactive tool is displayed as an icon or interactive input field that is selectable by the member 102 to initiate an action to achieve a new compensation status. The interactive tool is displayed within the context of the display of the information regarding the member's 102 compensation status.

The interactive tool may enable member interaction, such as messaging between members within or outside of a member's relationship network. Such a message may be sent via a social networking platform within the motivation platform. For example, the member 102 may act on intelligence provided via the commissioning interface 404 that the member 406 can achieve a new entity group by signing up one new member. The member 102 may send a message 412 to the member 406, such as via an interactive tool presented within the context of the presentation of the intelligence that enables communication. The message 412 may be a social network message posted to a message feed, an email, a text message, or other message type. The message 412 may be an offer for help, a motivational message, and so forth. The message 412 may be partly or completely composed by the motivation platform, to reduce the effort on behalf of the member 102 required to send the message 412. But control of the content of the message 412, and the decision to send the message 412, resides ultimately with the member 102.

The interactive tool may enable the member 102 to invite new members to join his or her relationship network—and sign up for mobile or other service—via a separate social media provider, such as the social media provider 204, through email—such as though an email provider 404—or through other means. The interactive tool may enable the member to initiate an instant messaging session with a prospective or existing member of the relationship network. The interactive tool may enable the member 102 to initiate a voice or video call or chat with a prospective or existing member, such as member 406, of their relationship network. The interactive tool may enable the member 102 to post a selectable link to his or her social media page—such as via the social media provider 204—that enables prospective members to sign up for service and/or to learn more about the service. Other selectable tools are possible without departing from the scope of embodiments.

The member 406 may access the motivation platform using a mobile phone computing device, such as mobile computing device 408. (Member 102 may also access the motivation platform using a mobile computing device such as mobile computing device 308.) Since the mobile computing device 408 may have a smaller and/or touch-enabled display than the computing device 402, the motivation platform may provide a commissioning interface 410 that is designed for display on a smaller screen to the mobile computing device 408. The commissioning interface 410 may have a different appearance that the commissioning interface 404, but provide the same or similar information regarding compensation status and the same or similar interactive tools. The interactive tools provided on the commissioning interface 410 may be optimized for a mobile phone. For example, the interactive tool may enable the member 102 to directly place a telephone call or send a Short Message Service (SMS) message through the mobile service provider to a prospective member.

Next, example relationship networks and a corresponding commissioning model are described. But embodiments of the present disclosure are not limited to these example relationship networks and commissioning models. Example motivation tools according to embodiments can be applied outside of the direct sales environment, and are therefore applicable to commissioning models that do not necessarily utilize a relationship network concept.

### Example Relationship Networks

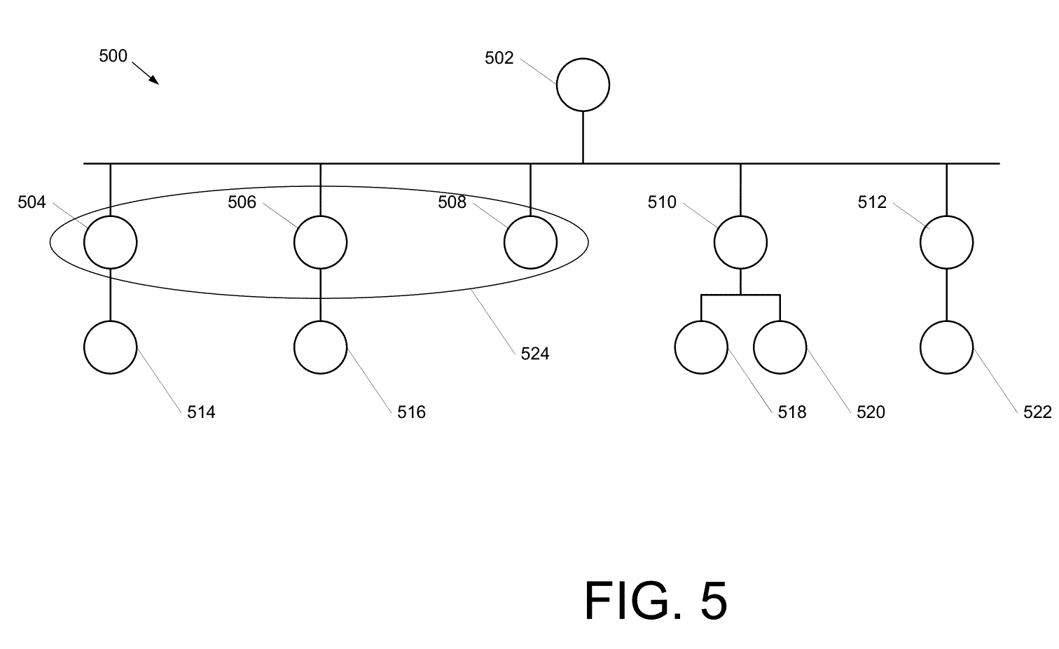

FIGS. 5-7 illustrate example relationship networks. Revenue sharing models according to embodiments utilize the size of a member's relationship network, such as the number of entity groups within the relationship network, to determine the level of compensation provided to members. An example revenue sharing model—described with reference to FIGS. 5-7—includes several components meant to address various stages of development of a member's relationship network. The first phase of the example revenue sharing model provides incentives for the member to recruit new entities to the network. The first phase is put in place during a ramp-up period, such as for a period of time between 30 and 120 days, or other time period. The second phase of the example revenue sharing model provides incentives for a member to assist his personal entity connections—those entities that the member directly recruited—to recruit new members. The second phase of the example revenue sharing model may also last for a limited period of time, such as for the first 30-120 days of the member's association with the model. The third phase of the example revenue sharing model provides various incentives over the long term for the member to continue to grow his or her relationship network and drive purchases by members of his network at any level within the relationship network.

FIG. 5 illustrates an example relationship network 500 during a first phase of an example revenue sharing model. An entity 502—such as member 102—sits atop the relationship network 500. The entity 502 may start out with no other entities within its relationship network 500, but eventually recruits personal connection entities 504-512. For example, the prospective member 106 may be one of the personal connection entities 504-512 within the relationship network 500. The personal connection entities 504-512 may also recruit additional network entities 514-522 into the relationship network 500.

In the first phase of the example revenue sharing model, which may last a specified period of time such as 30-120 days or other time period, the entity 502 receives a one-time and/or monthly bonus based at least in part on the number of personal connection entities within the relationship network 500. In one non-limiting example, the entity 502 is provided with a one-time per-connection bonus, such as a $5 bonus or other bonus or compensation (such as gift cards, vendor credit, etc.), for each one of personal connection entities 504-512 within the relationship network 500. Because there are five personal connection entities in the example relationship network 500, entity 502 may receive, according to this example, a $25 one-time bonus. These bonuses may be monthly recurring, such as during the 30-120 day ramp-up period, some period of time longer than the ramp-up period, or indefinitely for as long as personal connection entities 504-512 signed up during the ramp-up period remain part of the relationship network 500.

During the first phase of the example revenue sharing model, the member may also receive monthly recurring or one-time compensation based at least in part on the number of entity groups within its personal connection entities 504-512. In the example shown in FIG. 5, an entity group is characterized as having three entities (a “trio”), and personal connections 504, 506, and 508 form an entity group 524. Other entity groups, having different numbers of entities, may be used without departing from the scope of embodiments. Were entity 502 in the example shown in FIG. 5 to recruit one more personal connection entity, then relationship network 500 would have two entity groups. Were the entity 502 then to recruit a further three, six, or nine additional personal connection entities, then the relationship network 500 would have three, four, and five entity groups, respectively.

In a non-limiting example, the example revenue sharing model may provide members with a one-time entity group bonus for recruiting personal connection entities during a ramp-up period (or other time period) according to the following table:

TABLE 1

| Number of | |
|---|---|
| entity groups | One-time bonus |
| 1 | $50 |
| 2 | $100 |
| 3 | $200 |
| 4 | $300 |

Upon recruiting the first entity group within its personal connection entities, the entity 502 would receive a $50 bonus. Upon recruiting the second entity group, the entity 502 would receive an additional $100 bonus, and so forth. Were the entity 502 to recruit four entity groups (twelve total personal connection entities), the entity 502 would receive a total bonus of $650 ($50+$100+$200+$300). More or fewer entity group bonus levels, and smaller or larger bonuses may be paid at the different levels, without departing from the scope of embodiments. The first phase of the example revenue sharing model thus provides an incentive for the entity 502 to bring in personal connection entities during the ramp-up period.

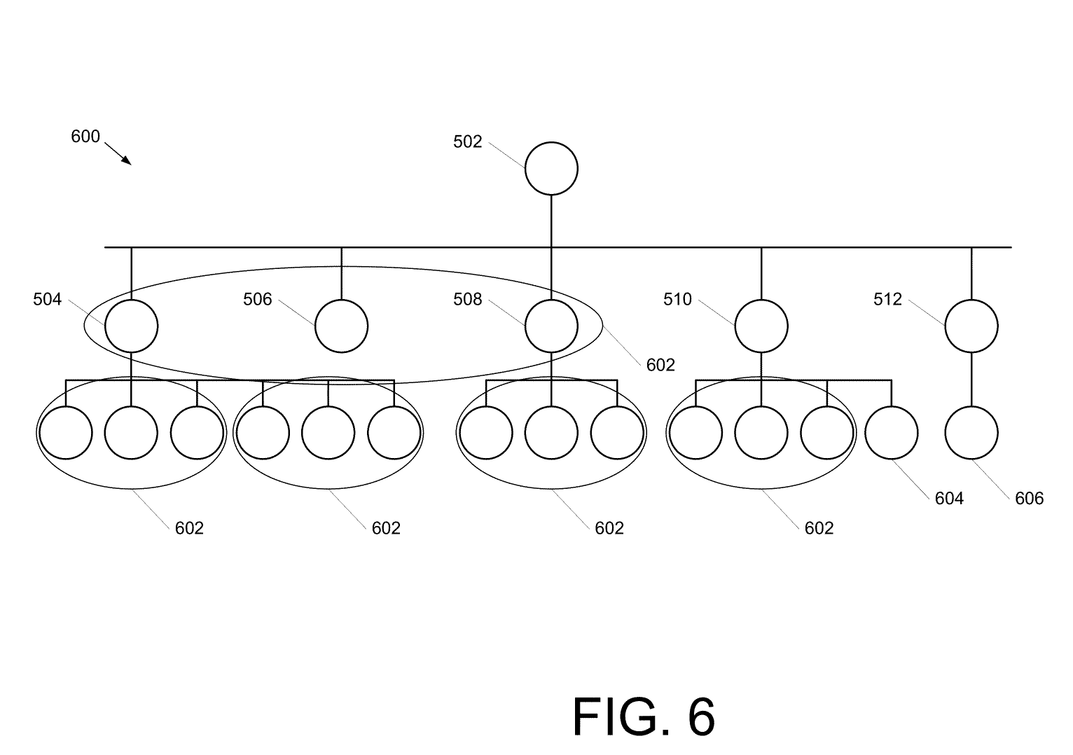

FIG. 6 illustrates an example relationship network 600 during a second phase of an example revenue sharing model. The entity 502 sits atop the relationship network 600. In the example shown in FIG. 6, the relationship network 600 includes personal connection entities 504-512. The personal connection entities 504-512 may also recruit additional network entities into the relationship network 600.

During the second phase of the example revenue sharing model, the entity 502 is provided with compensation based at least in part on the number of personal entity groups 602 within a personal network portion of the relationship network 600. In the example shown in FIG. 6, a personal entity group is characterized as having a predetermined number of entities, such as three entities (a “trio”), with direct connections to a common one of personal connection entities 504-512. A personal entity group may have more or fewer entities without departing from the scope of embodiments. In one non-limiting example, as illustrated in Table 2, the entity 502 is provided a one-time or recurring bonus of $20 based at least in part on the number of personal entity groups 602 within relationship network 600. In the example shown in FIG. 6, network entities 510, 512, 604 and 606 are part of a personal network portion of the relationship network 600, but are not part of a personal entity group. Were the entity 502 to add one more personal connections, or were either of personal connection entities 510 or 512 to add two more entities to the relationship network 600 directly under them, then relationship network 600 would have an additional personal entity group.

TABLE 2

| Number of | |
|---|---|
| personal entity | |
| groups | One-time bonus |
| 1 | $20 |
| 2 | $40 |
| 3 | $60 |
| 4 | $80 |

As discussed above with respect to FIG. 5, the personal connections entities 504-512 receive compensation for bringing in personal connection entities during at least the first phase of the revenue sharing plan. And the example revenue sharing model also provides an incentive, during at least the second phase, for entity 502 to assist the personal connection entities 504-512 in bringing in more entities, thereby aligning the interests of the entity 502 and the personal connection entities 504-512.

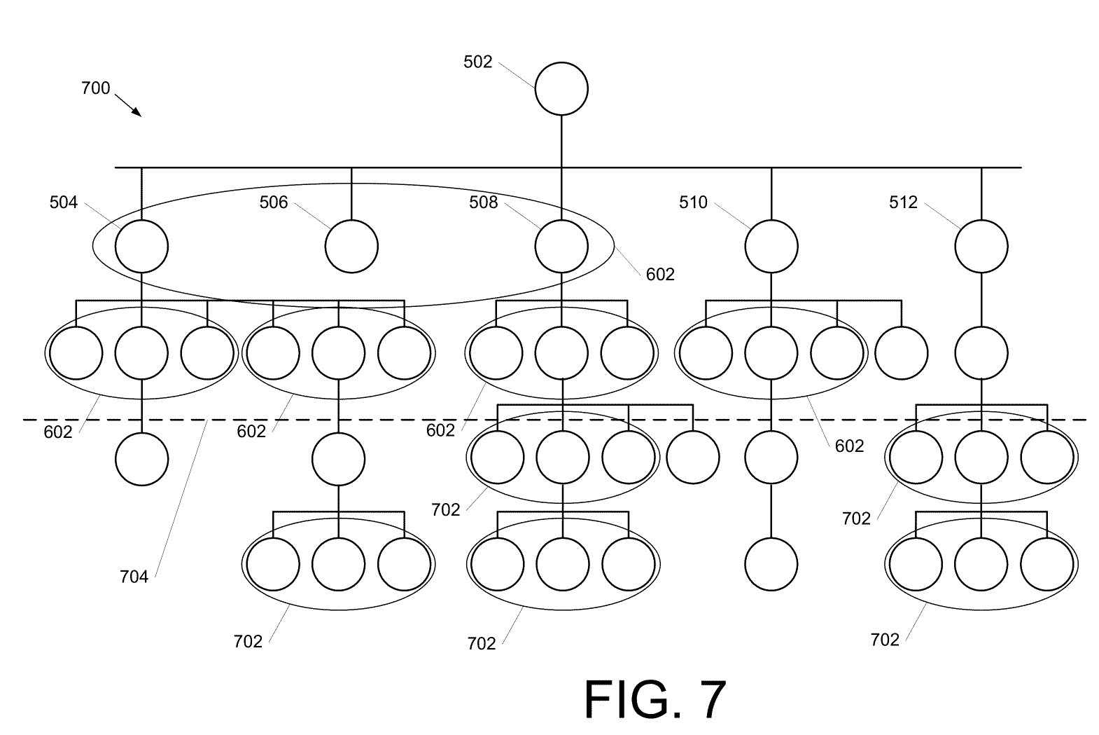

FIG. 7 illustrates an example relationship network 700 during a third phase of an example revenue sharing model. The entity 502 sits atop the relationship network 700. In the example shown in FIG. 7, the relationship network 700 includes personal connection entities 504-512. In the third phase of the example revenue sharing model, which may last an indefinite period of time for as long as the entity 502 remains a member, the entity 502 receives compensation for the number of personal entity groups 602 within a personal network and/or the number of network entity groups 702 within an extended network of the relationship network 700. In the example shown in FIG. 7, the personal network is defined as those entities and entity groups above line 704, thereby including two levels of entities within the personal connection network. Embodiments include relationship networks that include more or fewer levels within the personal connection network. The extended network may be defined as including those levels below the line 704. A network entity group 702 is characterized as having a predetermined number of entities (such as three entities, i.e., a “trio”) with connections to a common one of a network entity other than the personal connection entities 504-512. A “network” entity is either a personal connection entity or a non-personal connection entity.

The entity 502 receives compensation based at least in part on the number of entity groups, including the number of personal entity groups, within the relationship network. An entity group is either a personal entity group or an entity group. In embodiments, the entity is provided with compensation based at least in part on a combination of the number of entity groups and the number of the entity groups that are personal entity groups. The following table is a non-limiting example of a revenue sharing model that provides compensation based at least in part on a combination of the number of entity groups and the number of entity groups that are personal entity groups.

TABLE 3

| | | | No. | | | | | |
|---|---|---|---|---|---|---|---|---|
| | | | which | | | One- | | |
| | | No. of | are | | | time | Monthly | |
| | | network | personal | | | Career | Career | |
| | | entity | entity | | % | Path | Path | Product |
| Band | Tier | groups | groups | Line Rule | Rule | bonus | Bonus | Sales % |
| 1 | 1a | 1 | 1 | 1 | 100% | $0 | $0 | 3.3% |
| | 1b | 3 | 1 | | | $0 | $20 | |
| | 1c | 5 | 2 | | | $0 | $50 | |
| 2 | 2a | 10 | 2 | 3 | 50% | $800 | $200 | 2.1% |
| | 2b | 25 | 3 | | | $0 | $500 | |
| | 2c | 50 | 4 | | | $0 | $1000 | |
| 3 | 3a | 100 | 6 | 6 | 40% | $3000 | $2000 | 1.05% |
| | 3b | 200 | 7 | | | $0 | $3000 | |
| | 3c | 300 | 8 | | | $0 | $4000 | |
| 4 | 4a | 400 | 10 | 9 | 40% | 5000 | $5000 | .35% |
| | 4b | 500 | 11 | | | $0 | $6000 | |
| | 4c | 600 | 12 | | | $0 | $8000 | |
| 5 | 5a | 800 | 14 | 12 | 40% | $15,000 | $10,000 | .35% |
| | 5b | 900 | 16 | | | $0 | $15,000 | |
| | 5c | 1000 | 20 | | | $30,000 | $20,000 | |

Table 3 is split up into fifteen compensation tiers grouped into five compensation bands. Although the five compensation bands are labeled 1-5, and the fifteen compensation tiers are labeled 1a, 1b, 1c, and so forth, other labels or names may be used in various embodiments. Also, more or fewer tiers and/or compensation bands may be used in various embodiments. According to the example shown in Table 3, the entity 502 obtains a total of one entity groups, of which at least one entity group is a personal entity group (an entity group within the personal network portion of relationship network 700), in order to reach compensation tier 1a. Thus, as long as the entity 502 has at least one personal entity group, the entity 502 achieves compensation tier 1a. To reach the 1b compensation tier, the entity 502 obtains three entity groups in the relationship network 700, of which at least one is a personal entity group. To reach tier 3b, the entity 502 obtains 200 entity groups, of which at least seven are personal entity groups, and so forth.

The entity 502 is provided with either one-time compensation or a monthly compensation based at least in part on the achieved compensation tier and/or compensation band. In the example shown in Table 3, achieving compensation tier 1c results in the entity 502 receiving $50/month in compensation. Achieving compensation tier 2a, on the other hand, results in the entity 502 receiving a one-time bonus of $800 and $200/monthly compensation. The entity 502 receives a one-time bonus of $800 based at least in part on achievement of a compensation tier within a compensation band that the entity 502 had not previously achieved.

The entity 502 may also receive a personal network bonus or compensation based on the number of entity groups within the personal network. This is in addition to the monthly or one-time career path bonus described in Table 3, and may be separate from the compensation tier determination. In embodiments, the entity 502 may receive a one-time or recurring personal network bonus for every n^{th} entity group within the personal network. In one example, the entity 502 receives the personal network bonus for every third entity group (which may be called a “triple trio” or “trip trio” in embodiments where three entities form an entity group), and thus would receive increased personal network bonuses for every 3^{rd}, 6^{th}, 9^{th}, and 12^{th} personal entity group, and so on.

Other personal network bonuses are possible without departing from the scope of embodiments. For example, the entity 502 may be compensated based on the number of entities (not the number of entity groups) within the personal network. Also, a personal entity group within the personal network may have fewer or more entities than an entity group within the extended network. In one such example, a personal entity group includes three entities while an entity group within the extended network includes five entities.

The entity 502 receives compensation based at least in part on the number of entities within the relationship network 700. When determining the compensation tier or band that the entity 502 achieves, it does not matter, in embodiments, how many levels below the entity 502 the entities or entity groups within the extended network are. The entity 502 achieves the same compensation tier for entities far down in the extended network as for those closer to the top of the extended network. Thus, the entity 502 has an incentive to assist entities anywhere within their relationship networks recruit new entities.

Achieving a compensation tier or band may be subject to various constraints. Two example constraints are the line rule and the percent rule, as are described below. Other constraints are possible without departing from the scope of embodiments.

### Line Rule

The line rule constraint, as indicated by the “line rule” column in Table 3, indicates the number of personal connection entities that the entity 502 achieves in order to achieve a particular compensation band. In the example shown in Table 3, to achieve compensation band 3, the entity 502 obtains at least six personal connection entities (not personal entity groups). Thus, where the line rule constraint applies, the compensation tier or band achieved by the entity 502 is determined both by the number of entity groups within the personal network (the fourth column of Table 3) as well as the number of personal connection entities.

### Percent Rule

The Percent rule constraint, as indicated by the “% rule” column in Table 3, indicates a maximum percentage of the network entities or entity groups that are allowed to come under a single personal connection entity in order to achieve a compensation tier. In the example shown in Table 3, to achieve compensation band 3, the entity 502 obtains at least 100 entity groups with no more than 40% of them connected to the entity 502 through a single personal connection entity. For example, if the entity 502 had 100 entity groups in the network 700, but more than 40 of those entity groups were under personal connection entity 504, then the entity 502 would not achieve compensation band 3, and would remain at compensation tier 2c within compensation band 2.

### Purchase Revenue Bonuses

The “product sales” column in Table 3 indicates a percentage of revenues that the entity 502 receives for certain purchases made by entities within the relationship network 700. As noted elsewhere within this Detailed Description, entities may be provided with compensation by depositing funds into a bank account connected to a transaction card. The entities use the transaction card to make purchases. In other embodiments, alternative payment mechanisms are used to access the compensation funds. For example, the entity 502 may utilize payment technology on their mobile device, such as the mobile device 104, to make payments.

When purchases are made by the entities at participating retailers, the participating retailers provide a portion of the purchase back to the revenue sharing model. A percentage of the revenue provided to the revenue sharing model is set aside for compensating the entities (such as the entities in the relationship network 700, as well as other entities in other relationship networks). Depending on the compensation tier achieved by the entity 502, the entity receives a first purchase bonus that is based at least in part on a percentage of a first portion of the set-aside revenue that is attributable to the purchases made by the entities within relationship network 700.

In embodiments, a second purchase bonus not shown in Table 3 is paid to entities based at least in part on their own personal purchases. For example, a second portion of the set-aside revenue may be paid to the entities based at least in part on a ratio of the entities' personally-generated revenue to overall revenue generated from all purchases by all entities. Thus, in one example, if purchases made by the entity 502 account for 5% of all revenue generated from purchases at participating retailers, then the entity 502 would receive 5% of the second portion of the set aside revenue.

### Top Performer Bonus

Revenue sharing models according to embodiments also provide a top performer bonus, paid to those entities participating in the revenue sharing model designated as a “top performer.” The top performer bonus may be paid out of a pool of funds that represents a percentage of gross revenues, or some other pool. The top performer bonus is paid to the top performers for certain activities, such as signing up personal connection entities, adding entity groups to their networks, advancing to a new compensation tier or compensation band, and so forth. The top performer bonus may be provided on a daily, weekly, monthly, quarterly, or annual basis, or on some other time basis.

### New Member Bonus

Revenue sharing models according to embodiments also provide a new member bonus, paid to entities that have joined within a certain period of time, such as for example between 30-120 days or other time period. The new member bonus may be paid out of a pool of funds that represents a percentage of gross revenues, or some other pool. The top performer bonus is paid to the new members for performing certain activities, such as attending conferences, webinars, meetings, signing up personal connection entities, adding entity groups to their networks, and so forth.

### Example Commissioning Interfaces

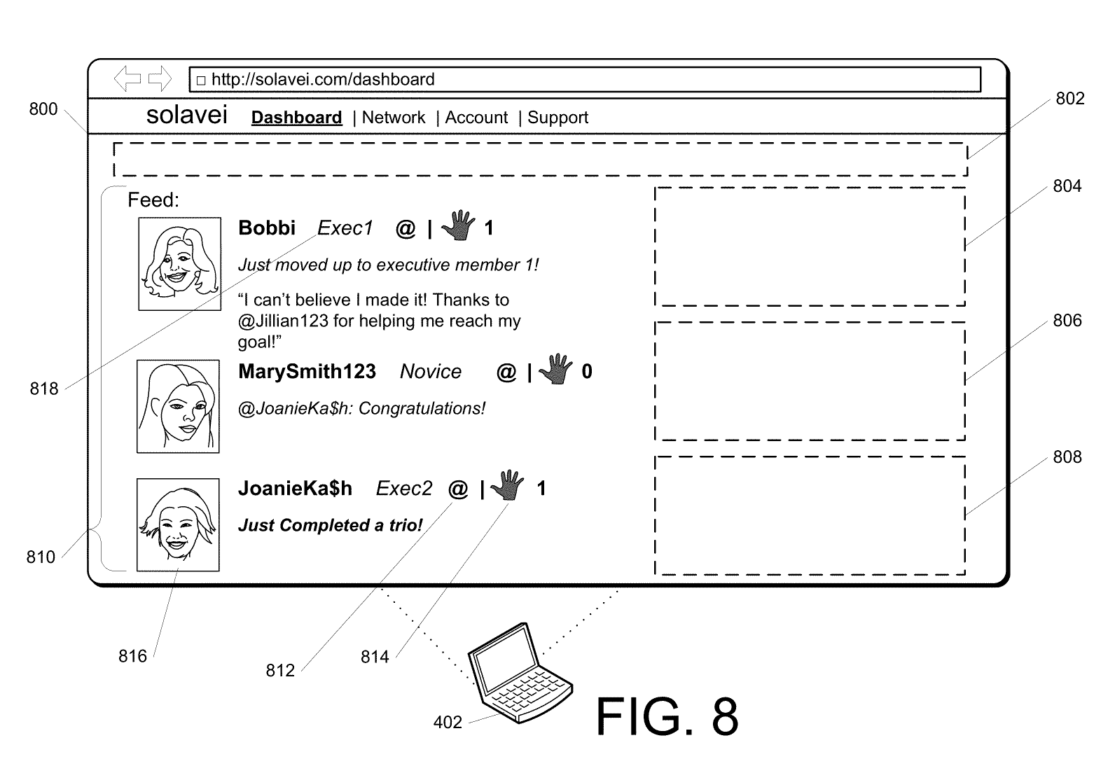

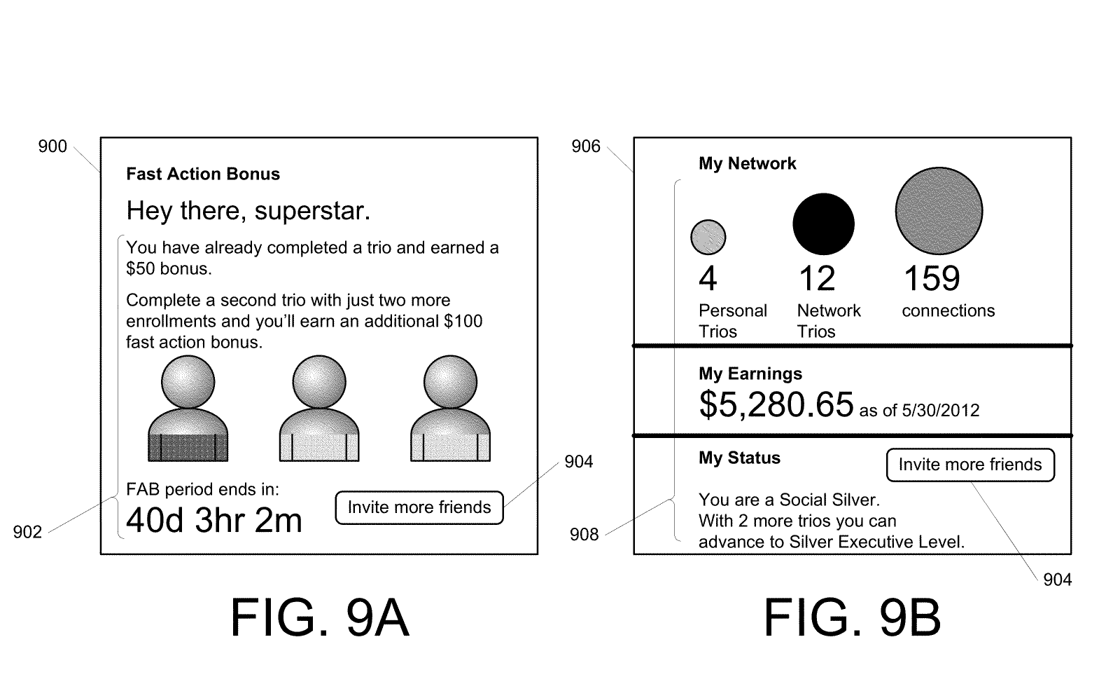

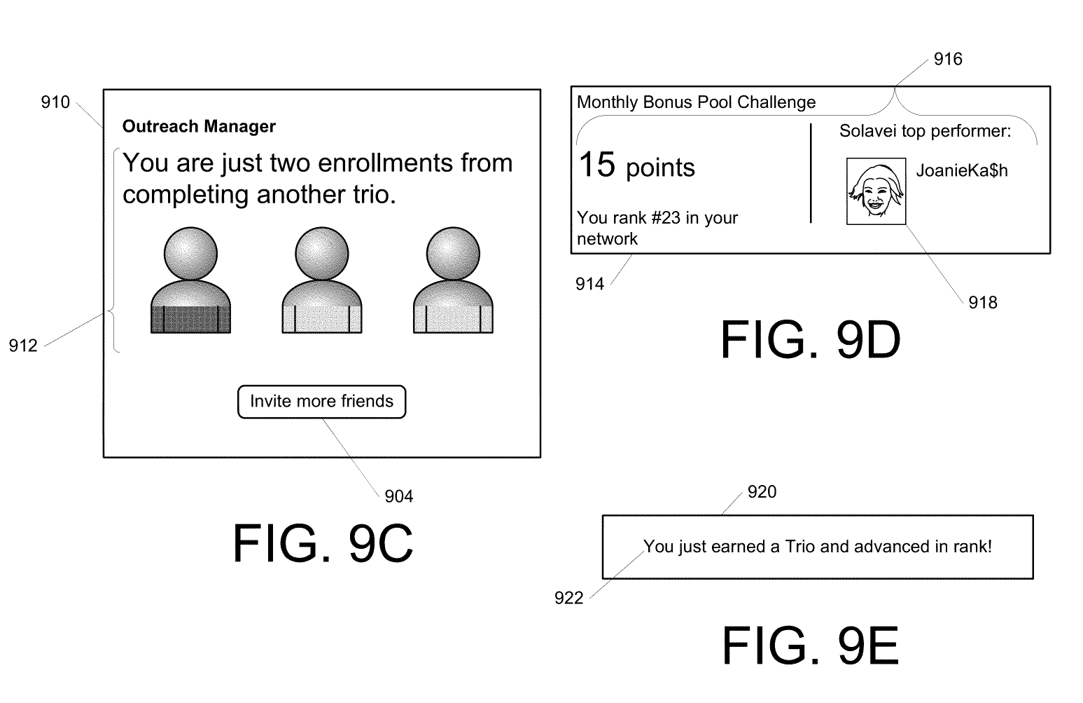

FIG. 8 illustrates an example commissioning interface 800 that includes notification placeholders and interactive tools for enabling sales activity. The commissioning interface 800 includes multiple notification placeholders 802-808. The motivation platform 126 determines type or types of notifications to place into the notification placeholders 802-808 based, for example, on a current compensation status of the entity who has logged into the commissioning interface 800. Example notifications are shown in FIGS. 9-11.

The notification placeholders 802-808 may include real-time or near real-time updates to allow the entity viewing the interface to see what is currently happening within their relationship network. As described in more detail below, various events may trigger updates, which may be placed into a queue to be presented into one or more of notification placeholders 802-808. For example, a notification may be presented that tells the entity that the entities within their relationship networks have made new purchases at participating retailers, that new entities have signed up to be a part of their relationship network, or that a new entity group has been completed within the entity's extended network.

The notification placeholders may also include interactive tools to enable the entity to initiate action to achieve a new compensation status. The notification placeholders may include information about the entity's compensation status, such as the number of entities or entity groups within their relationship network or the amount of money earned in a current compensation period. The interactive tools may be, in various embodiments, displayed within the commissioning interface 800 outside of the notifications 802-808. Thus, displaying an interactive tool within the context of the information regarding the entity's compensation status includes displaying the interactive tool anywhere within the commissioning interface 800.

Commissioning interface 800 also includes a social network feed 810. This social network feed is part of a social network platform within the motivation platform 126. It may alternatively be hosted outside of the motivation platform, and may be part of a social network platform that is not exclusively for participants in the direct sales model. For example, the social network feed 810 may be provided wholly or partly by the social media provider 204. In embodiments, the social network feed 810 may be provided in part by an external social media provider and in part by a social network platform hosted by the motivation platform 126.

The social network feed 810 may include various tools for interacting with entities within the relationship network. For example, the entity viewing the commissioning interface 800 may select the “@” icon 812 to reply to a message within the feed. For example, in the example feed shown in FIG. 8, entity MarySmith123 has replied to entity JoanieKa$h's message, as indicated by the “@JoanieKa$h” tag that begins MarySmith123's message. The social network feed 810 may include both automatically generated messages, shown in FIG. 8 in italics that indicate accomplishments or achievement of new compensation status. For example, the automatic message posted on behalf of JoanieKa$h is “Just completed a trio!” The automated messages may be combined with messages that the entity provides. For example, the automatically generated message on behalf of entity Bobbi “Just moved up to executive member 1” is combined with a message typed or entered by Bobbi, shown in quotations. Users may also indicate an affirmation of the messages, such as by selecting the “high-five” icon 814.

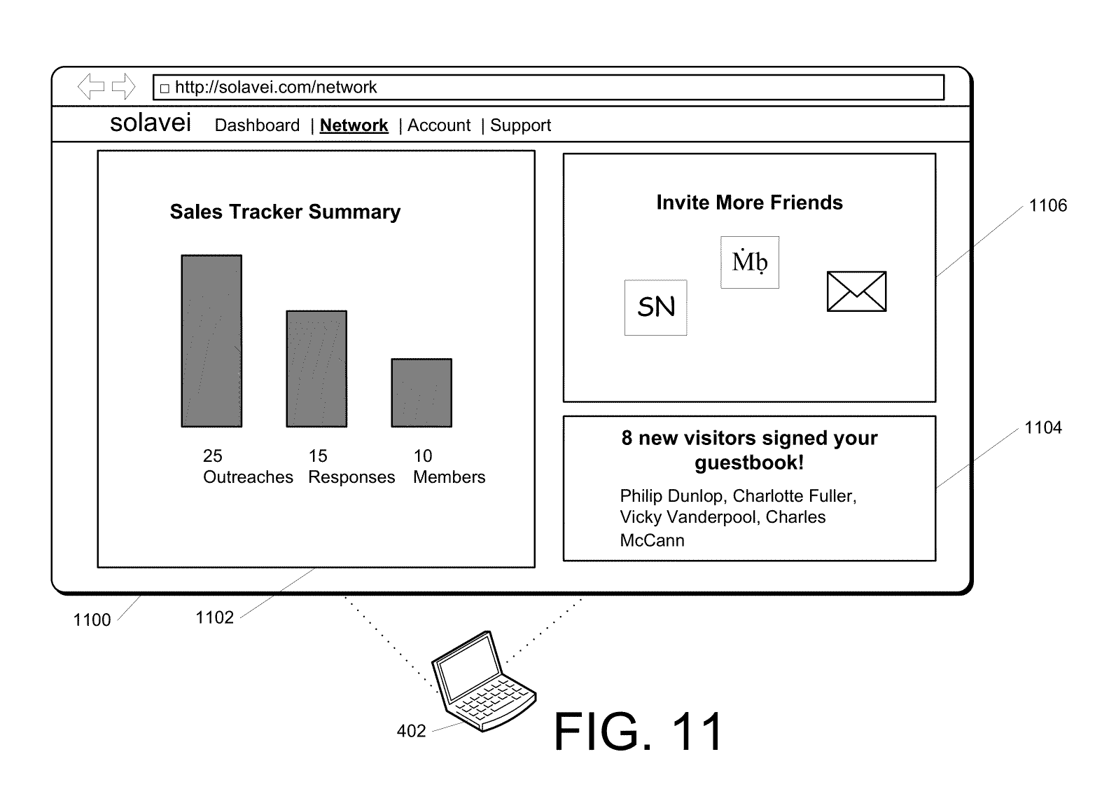

Selecting an entity's icon, such as icon 816, may reveal information about the associated entity and/or reveal interactive tools to communicate with those entities, such as is described in more detail with respect to FIG. 11. Other layouts and content may be provided within compensation interface 800 without departing from embodiments.

Also, the feed 810 may indicate a member's rank 818, which may correspond to the member's compensation band or tier. Thus, members can be made aware of each others' ranks. The feed therefore enables interaction between members, as well as competition. Members at lower ranks can be inspired by higher-ranking members to take action and to cooperate in order to grow their networks. This drives additional sales activity and revenue.

Next, various notification types will be described which may be displayed within one or more of the notification placeholders 802-808. FIGS. 9A-9E illustrate example notifications and interactive tools displayed within notification placeholders within a commissioning interface.

FIG. 9A illustrates notification 900. Notification 900 may be presented within one or more of notification placeholders 802-808 (or in other notification placeholders of other commissioning interfaces), for example, during a particular phase of a commissioning model—such as the phase described with reference to FIG. 6 during which the entity receives bonuses for the number of personal entity groups that the entity brings into its relationship network. The notification 900 includes information 902 regarding the compensation status of the entity. In the example shown in FIG. 9A, the information 902 tells the entity that they have completed a trio (an entity group of three entities), that they have earned a $50 bonus, and that the period of for earning bonuses during this phase of the commissioning model will be over in 40 days, three hours, and two minutes. The information 902 also informs the entity of one or more actions that the entity can take to achieve a new compensation status: complete a second trio with two more enrolments to earn additional $100 bonus. The three figurines within the information 902 shows the number of entities that comprise an entity group, and the two grayed-out figurines indicate that the entity is to enroll two more in order to achieve a new entity group. Other information 902 may be provided in the same or different form without departing from the scope of embodiments.

Within the context of the display of the notification 900, interactive tool 904 is also displayed. In the example shown within the notification 900, the interactive tool 904 enables the entity to invite more prospective entities to join their relationship network in order to achieve another entity group. Selection of the interactive tool 904 may launch a screen where the entity can select one or more contacts to message, select a friend to initiate a voice or video call with, and so forth. Other invitation methods may be utilized without departing from the scope of embodiments.

In embodiments a different interactive tool besides interactive tool 904—or no interactive tool at all—may be displayed within the notification 906. For example, an interactive tool could be displayed within the commissioning interface 800 within a different notification placeholder than the one that notification 900 is displayed in, or in a portion of the commissioning interface 800 other than a notification placeholder.

FIG. 9B illustrates notification 906. Notification 906 may be presented within one or more of notification placeholders 802-808 (or in other notification placeholders of other commissioning interfaces), for example, during a particular phase of a commissioning model—such as the phase described with reference to FIG. 7 during which the entity receives compensation for the number of personal entity groups within a personal network and/or the number of network entity groups within an extended network of their relationship network. The notification 906 includes information 908 regarding the compensation status of the entity. In the example shown in FIG. 9B, the information 908 informs the entity that they have four personal trios, twelve network trios, and 159 total connections. This information is also graphically represented by circles that represent the relative size of various aspects of the entity's relationship network. The information 908 also informs the entity that they have earned $5,280.65 in the current commissioning period and that the entity is a “Social Silver” compensation band/tier. The information 908 also provides one or more actions that the entity can complete to achieve a new compensation status: obtain two more trios within their relationship network to reach a new compensation tier.

The notification 906 also includes interactive tool 904. In embodiments a different interactive tool—or no interactive tool at all—may be displayed within the notification 906 without departing from the scope of embodiments. For example, an interactive tool could be displayed within the commissioning interface 800 within a different notification placeholder than the one that notification 906 is displayed in, or in a portion of the commissioning interface 800 other than a notification placeholder.

FIG. 9C illustrates notification 910. Notification 910 may be presented within one or more of notification placeholders 802-808 (or in other notification placeholders of other commissioning interfaces), for example, during a particular phase of a commissioning model—such as the phase described with reference to FIG. 7 during which the entity receives compensation for the number of personal entity groups within a personal network and/or the number of network entity groups within an extended network of their relationship network. The notification 910 includes information 912 regarding the compensation status of the entity. In the example shown in FIG. 9C, the information 912 informs the entity that the entity is two enrollments away from completing another entity group.

The notification 910 also includes interactive tool 904. In embodiments a different interactive tool—or no interactive tool at all—may be displayed within the notification 910 without departing from the scope of embodiments. For example, an interactive tool could be displayed within the commissioning interface 800 within a different notification placeholder than the one that notification 910 is displayed in, or in a portion of the commissioning interface 800 other than a notification placeholder.

FIG. 9D illustrates notification 914. Notification 914 may be presented within one or more of notification placeholders 802-808 (or in other notification placeholders of other commissioning interfaces), for example, during a particular phase of a commissioning model—such as the phase described with reference to FIG. 7 during which the entity receives compensation for the number of personal entity groups within a personal network and/or the number of network entity groups within an extended network of their relationship network. The notification 914 includes information 916 regarding the compensation status of the entity. In the example shown in FIG. 9D, the information 916 informs the entity that the entity has 15 points towards a “monthly bonus pool challenge” and identifies a top performer.

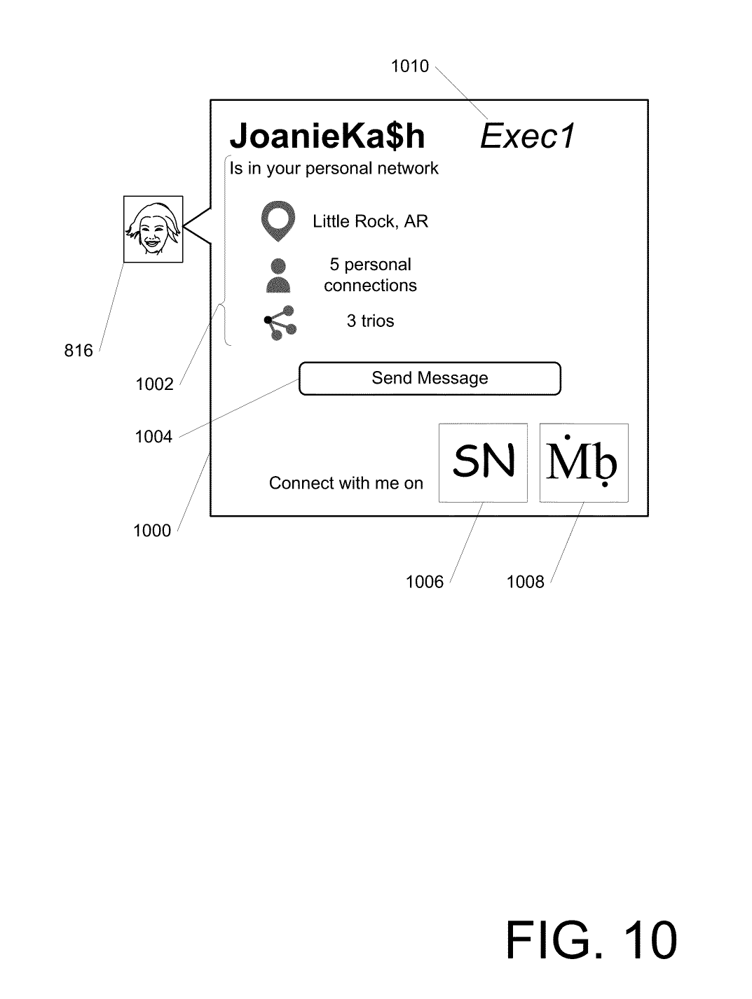

Selection of the icon 918 may reveal additional information about and/or tools for contacting the top performer as is described with respect to FIG. 10.

FIG. 9E illustrates notification 920. Notification 920 may be presented within one or more of notification placeholders 802-808 (or in other notification placeholders of other commissioning interfaces), for example, during a particular phase of a commissioning model—such as the phase described with reference to FIG. 7 during which the entity receives compensation for the number of personal entity groups within a personal network and/or the number of network entity groups within an extended network of their relationship network. The notification 920 includes information 922 regarding the compensation status of the entity. This information may be generated in real time by the motivation platform as new entities are added to the member's network, for example.

FIG. 10 illustrates a profile card 1000 that can be enabled by clicking on, touching (such as via a touch-screen display), positioning a pointer on, or otherwise selecting a user icon, such as the icon 816 in commissioning interface 800 or the icon 918 in the notification 914. The profile card 1000 may be displayed as overlay of a commissioning interface, such as the commissioning interface 800. The profile card 1000 may include information 1002 about the entity associated with the profile card 1000. Example information includes user name, rank, relationship to the entity viewing the profile card, number of personal trios, number of extended trios, number of total connections, a profile statement selected or generated by the entity, and so on. Some or all of this information may be information regarding the compensation status of the entity viewing the profile card 1000. Member's 816 rank 1010 is also viewable on the profile card 1000.

Various interactive tools, such as interactive tools 1004, 1006, and 1008 enable the entity viewing the profile card 1000 to contact, message, or otherwise interact with the contact Selection of interactive tool 1008 enables the entity viewing the profile card 1000 to send a private message to the entity. Selection of interactive tool 1006 or 1008 enables the entity viewing the profile card 1000 to connect with the entity via various social networking sites, such as may be hosted by the social media provider 204 or such as may be provided by the motivation platform 126. These interactive tools enable the entity viewing the profile card 1000 to initiate actions to achieve a new compensation status. For example, the entity viewing the profile card 1000 could message the entity associated with the profile card 1000 an offer to help recruit new members.

FIG. 11 illustrates an example commissioning interface 1100 that enables an entity to track sales activity. The commissioning interface 1100 includes a notification 1102 with information regarding a current compensation status of the entity associated with the commissioning interface 1100. For example, the information within the notification 1102 informs the entity that they have performed 25 “outreaches” (have contacted 25 prospective new members in various ways), that 15 of the prospective new members have responded to the outreaches in some way (such as by clicking on a link for information on the service), and that ten of those contacted have signed up for the service.

The commissioning interface 1100 may also include notification 1104, which informs the entity viewing the commissioning interface 1100 that one or more prospective new members have signed a “guestbook” for the entity. The “guestbook” may be a service hosted by the web service 114 that provides information and allows the prospective new members to indicate the member or entity from whom they first heard about the service. The identities of those signing the “guestbook” may also be presented, thereby enabling the entity to follow up with those individuals. All or part of the notification 1104 may be interactive to enable the entity to initiate messages or other communications to those entities that have signed the “guestbook.”

Within the context of the display of the notifications 1102 and 1104, an interactive tool 1106 is displayed. The interactive tool 1106 enables the entity associated with the commissioning interface 1100 to initiate actions to achieve a new compensation status. For example, selection of the interactive tool 1106 enables the entity to invite more prospective members to join the entity's relationship network. The individual icons within the interactive tool 1106 may be individually selectable to generate emails or social networking messages, connect with individuals via various social networks, post messages on a social networking service, and so forth. Selection of interactive tool 1106 may also bring up a screen that allows the entity to view contacts and/or add new contacts to a contacts database hosted by the motivation platform 126 or at some other location.

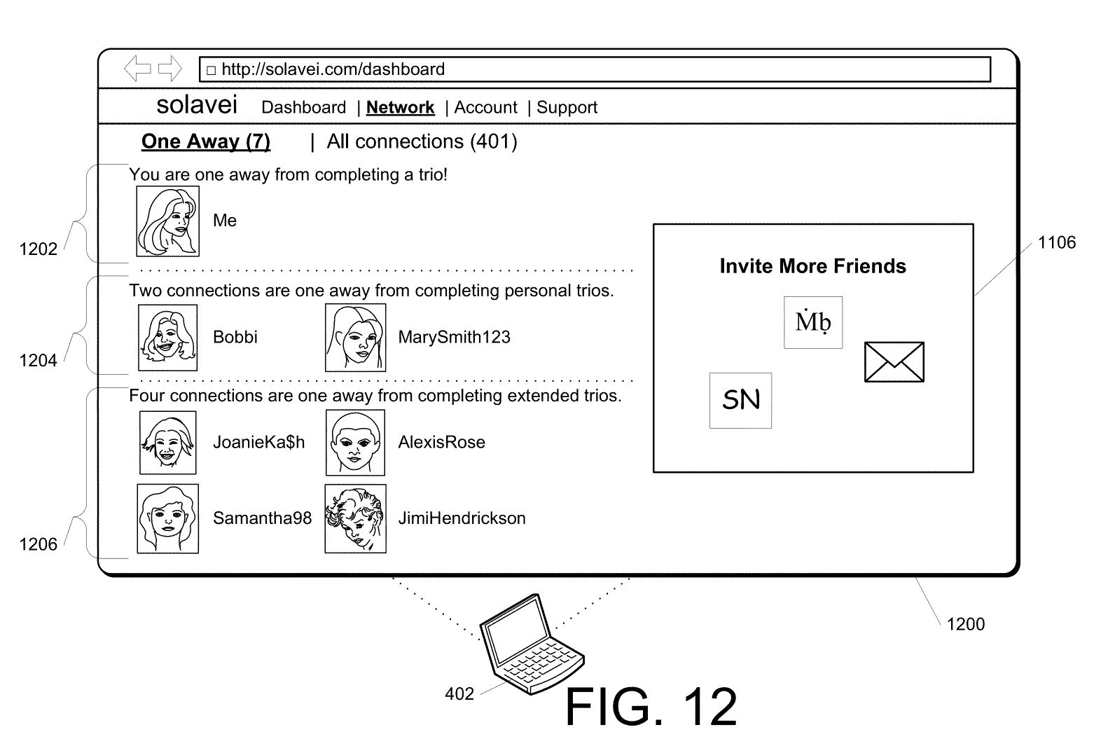

FIG. 12 illustrates an example commissioning interface 1200 that enables an entity to identify members of their relationship networks that are close to achieving new compensations statuses. The commissioning interface 1200 includes one or more notifications with information about a compensation status of the entity associated with the commissioning interface 1200. The notifications within the commissioning interface 1200 enables the entity to see the identities of those entities within his or her network that are within a certain range of achieving a new compensation status. In the example shown in FIG. 12, the notifications within the commissioning interface 1200 display the identities of those entities within the relationship network who are one entity away from achieving a new entity group within their own networks.

Notification 1202 informs the entity that he or she is personally one entity away from completing a new entity group. Notification 1204 identifies those entities within the relationship network that are one entity away from achieving a new personal entity group within their own personal networks. And notification 1206 identifies those entities within the relationship network that are one entity away from achieving a new extended entity group within their own extended networks.

Interactive tool 1106 is selectable to enable the entity to initiate an action to achieve a new compensation status. A different interactive tool may be displayed within the context of the notifications 1202, 1204, and 1206 without departing from the scope of embodiments.

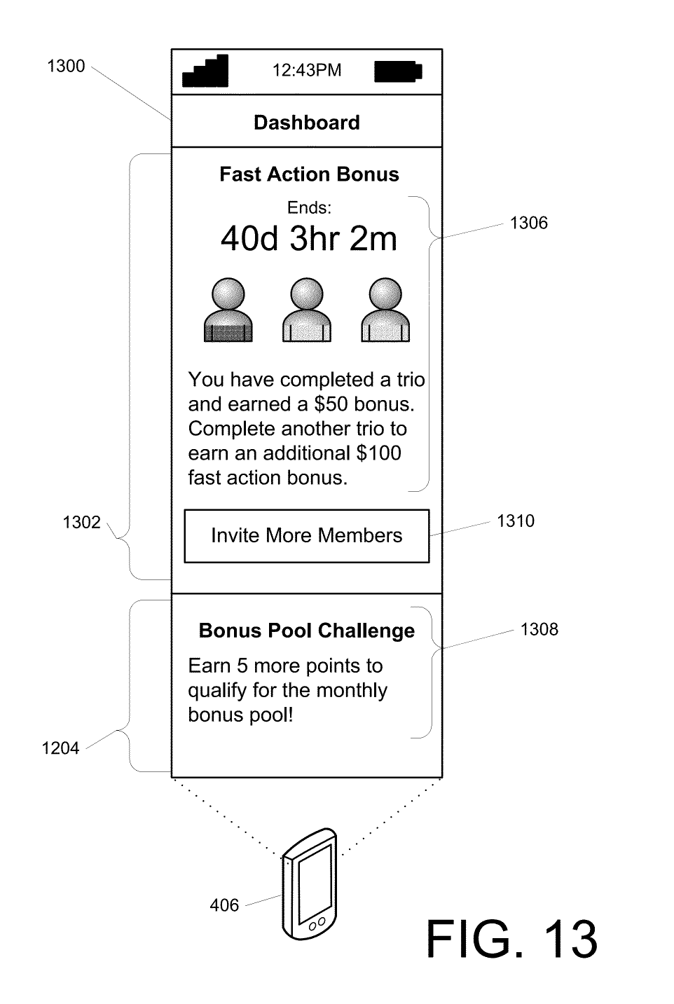

FIGS. 13-16 illustrate example commissioning interfaces with notifications and interactive tools for display on mobile devices. These are examples only, and other examples can be used without departing from the scope of embodiments. FIG. 13 illustrates a commissioning interface 1300. Commissioning interface 1300 includes notifications 1302 and 1304 displayed within respective notification placeholders. The notification 1302 includes information 1306 regarding a compensation status of the entity associated with the commissioning interface 1300. The notification 1304 also includes information 1306 regarding a compensation status of the entity associated with the commissioning interface 1300. Commissioning interface 1300 includes an interactive tool 1310 that enables the entity using the commissioning interface 1300 to initiate an action to achieve a new compensation level. In the example shown in FIG. 13, the interactive tool 1310 enables the entity to invite more prospective members to join the entity's relationship network, but other interactive tools to initiate the same or similar actions may be provided within commissioning interface 1300 without departing from the scope of embodiments.

Commissioning interface 1300 may be selected for display during a particular phase of a commissioning model—such as the phase described with reference to FIG. 6 during which the entity receives bonuses for the number of personal entity groups that the entity brings into its relationship network.

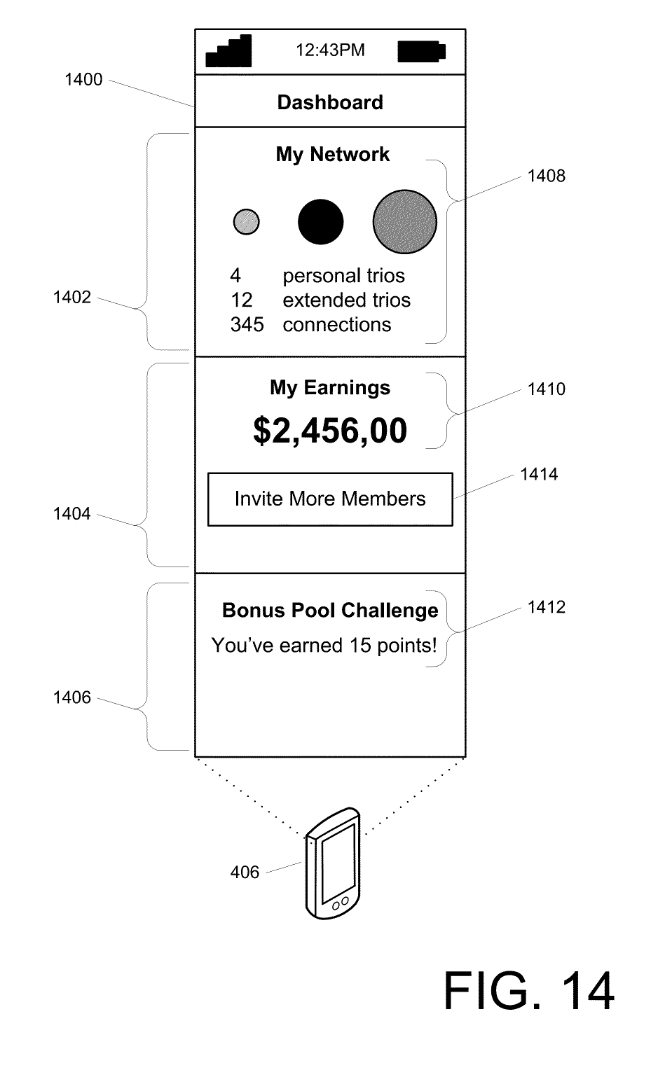

FIG. 14 illustrates a commissioning interface 1400. Commissioning interface 1400 includes notifications 1402, 1404, and 1406 displayed within respective notification placeholders. The notifications 1402, 1404, and 1406 include, respectively, information 1408, 1410, and 112 regarding a compensation status of the entity associated with the commissioning interface 1400. Commissioning interface 1400 includes an interactive tool 1414 that enables the entity using the commissioning interface 1400 to initiate an action to achieve a new compensation level. In the example shown in FIG. 14, the interactive tool 1414 enables the entity to invite more prospective members to join the entity's relationship network, but other interactive tools to initiate the same or similar actions may be provided within commissioning interface 1400 without departing from the scope of embodiments.

Commissioning interface 1400 may be selected for display during a particular phase of a commissioning model—such as the phase described with reference to FIG. 7 during which the entity receives compensation for the number of personal entity groups within a personal network and/or the number of network entity groups within an extended network of their relationship network.

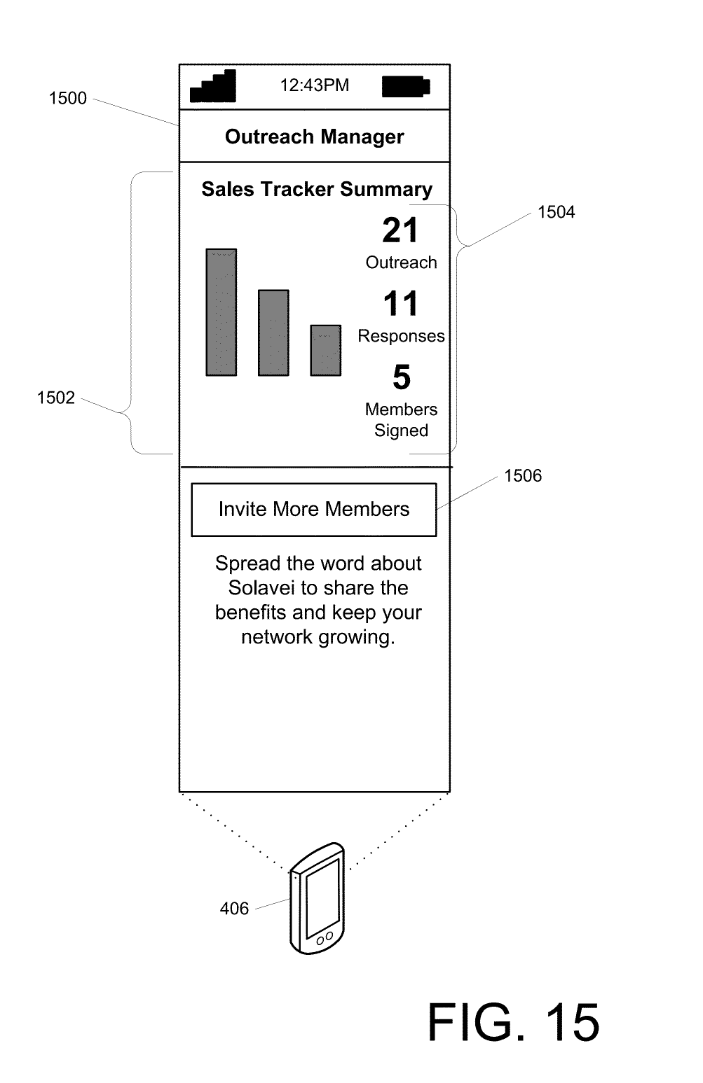

FIG. 15 illustrates a commissioning interface 1500. Commissioning interface 1500 includes notification 1502 displayed within a notification placeholder. The notification 1502 includes information 1504 regarding a compensation status of the entity associated with the commissioning interface 1500. Commissioning interface 1500 includes an interactive tool 1506 that enables the entity using the commissioning interface 1500 to initiate an action to achieve a new compensation level. In the example shown in FIG. 1500, the interactive tool 1506 enables the entity to invite more prospective members to join the entity's relationship network, but other interactive tools to initiate the same or similar actions may be provided within commissioning interface 1500 without departing from the scope of embodiments.

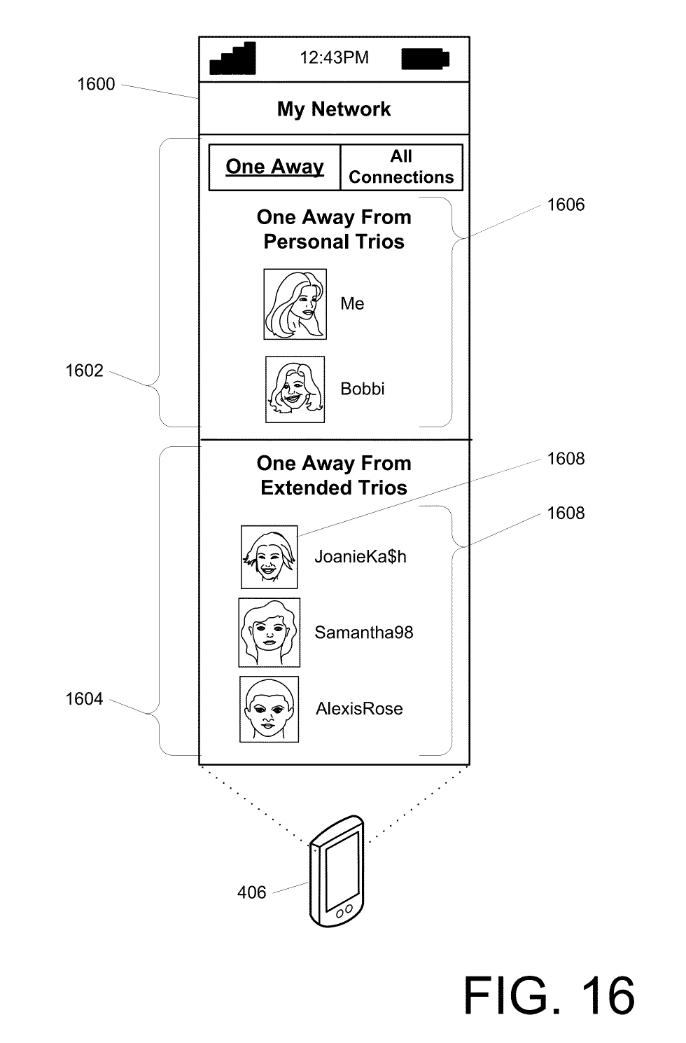

FIG. 16 illustrates a commissioning interface 1600. Commissioning interface 1600 includes notifications 1602 and 1604 displayed within respective notification placeholders. The notifications 1602 and 1604 include, respectively, information 1606 and 1608 regarding a compensation status of the entity associated with the commissioning interface 1600. In particular, the information 1606 and 1608 shown in FIG. 16 identifies the number of entities within the relationship network who are within a certain range of achieving a new compensation status of their own. The icons, such as icon 1610 (and/or its associated text), within the notifications 1602 and 1604 may be interactive tools that enable the entity using the commissioning interface 1600 to initiate an action to achieve a new compensation level. In the example shown in FIG. 1600, the icons enable the entity to message the associated entities identified by the icons, but other interactive tools to initiate the same or similar actions may be provided within commissioning interface 1600 without departing from the scope of embodiments.

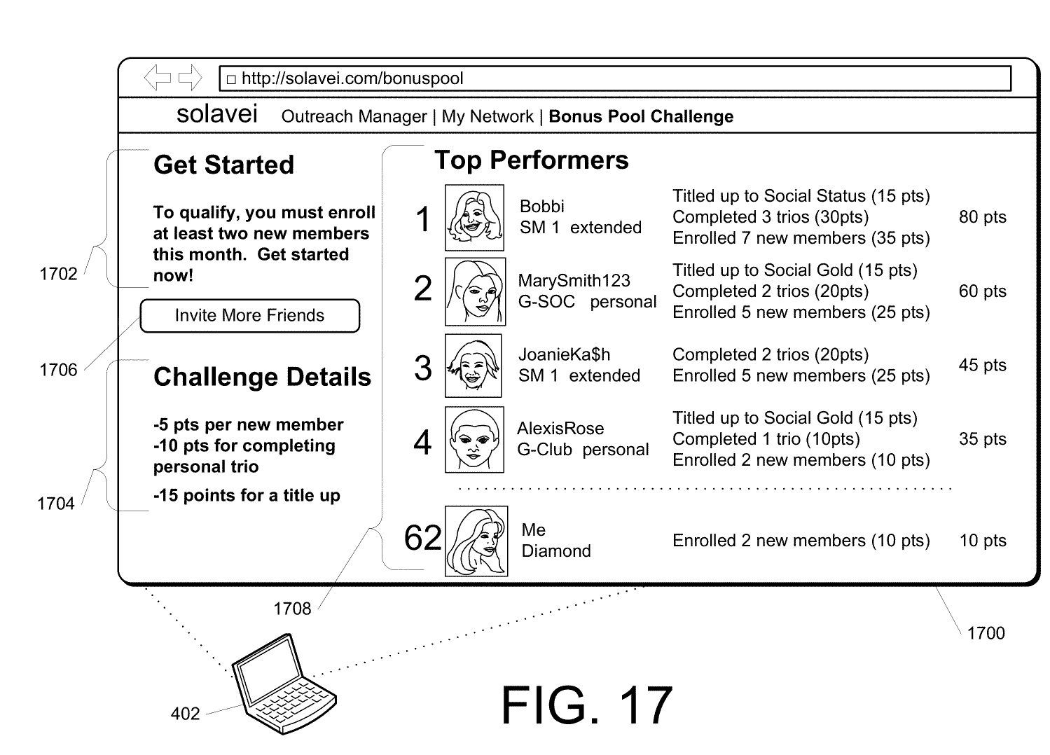

FIG. 17 illustrates an example commissioning interface 1700 that enables an entity to track progress on a bonus pool challenge competition. The commissioning interface 1700 includes information fields 1702 and 1704 that identify how the member can qualify for the competition, and how the member earns points towards the competition. Interactive tool 1706 enables the member to initiate action to achieve a new compensation level, and/or to earn points towards the bonus pool challenge competition.

The Top Performers area 1708 also shows the top performers in the competition and contrasts their performance with the member's status. Next to the entities' icons in the Top Performers area 1708 are the entities' user names, ranks (e.g., “SM 1”), and an indication of whether the entities are part of the member's personal network or part of the member's extended network. In the example shown in FIG. 17, the member is currently in 62^{nd} place and has 10 points. The Top Performers area 1708 also shows the tasks that the top performers and the member have completed to earn points. For example, entity Bobbi has titled up to “Social Status” and therefore earned 15 points for a “title up.” Hovering over or selecting an entity's icon may enable a profile card, such as the profile card 1000, to be displayed, thereby enabling the member to view additional information about the entity and to interact with the entity. By combining real-time information about the competition, and by providing the member with tools to take action and to interact with other members, the member is motivated and inspired to grow his or her network, thereby generating revenue growth.

### Example Computing System

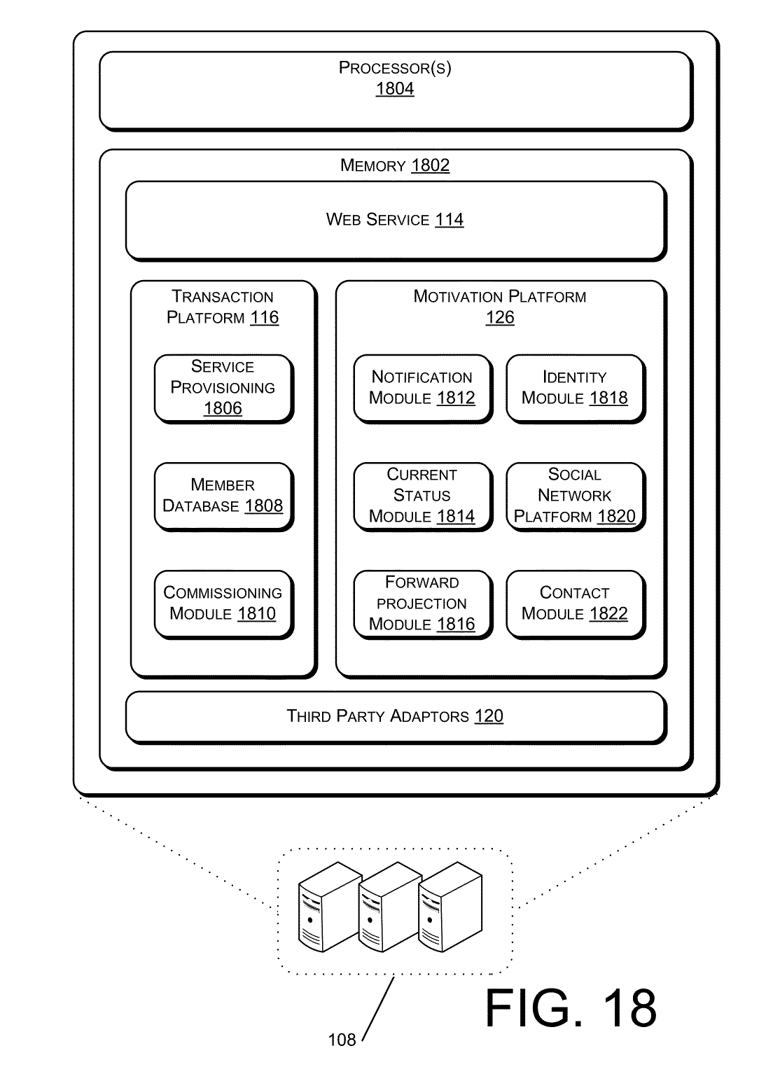

FIG. 18 is a block diagram of an example computing system usable to provide a transaction service 108. The transaction service 108 may be configured as any suitable computing device or computing devices capable of implementing member acquisition tools. According to various non-limiting examples, suitable computing devices may include or be part of personal computers (PCs), servers, server farms, datacenters, special purpose computers, tablet computers, game consoles, smartphones, media players, combinations of these, or any other computing device(s).

Memory 1802 may store program instructions that are loadable and executable on the processor(s) 1804, as well as data generated during execution of, and/or usable in conjunction with, these programs.

Memory 1802 includes the web service 114, the transaction platform 116, and the third party adaptors 120. The transaction platform 116 includes a service provisioning module 1806 which receives service provisioning information for a prospective member from the web service 114. The service provisioning request may be for a communication service (such as a wireless phone service), a television service, an energy service, or some other service. The service provisioning module 1806 initiates the provisioning of a new member service for the prospective member, which includes writing the prospective member's information to the member database 1808. The service provisioning module 1806 communicates with the third party adaptors 120 to facilitate the provisioning of the service for the prospective member, including the fulfillment of delivery of the handset or other device to the prospective member.

Additionally, the service provisioning module 1806 receives existing member information that corresponds to the member that is responsible for signing the prospective member up to new service. For example, the prospective member may sign up for the new service after clicking on a link to the transaction service 108 in the existing member's social networking page. In another example, the prospective member may sign up for the new service by interacting with the existing member who uses a member acquisition tool on their mobile device to sign up the prospective member to new service. As part of that process, the existing member's information is forwarded to the service provisioning module 1806. In the case of a soft link on the existing member's phone, and/or in the case of the prospective member clicking on a social networking link, the existing member information may be embedded within a resource identifier (such as a URL or URI). In any event, the service provisioning module 1806 causes the new service for the prospective member to be correlated in the member database 1808 with the existing member service. The prospective member may be provided with an option to verify the identity of the referring member.

A commissioning module 1810 is configured to initiate commissioning calculations for the members, such as based at least in part on a revenue sharing model according to various embodiments. This process includes looking up members in a member's network, as indicated by the correlations between the members' accounts in the member database 1808. In one example, if a first member signs up a second member, the first member receives a commission payment based at least in part on the second member's service payments. The commission payments may be calculated weekly, monthly, quarterly, annually, or at some other rate according to various embodiments. The commission payments may be one-time payments. Alternatively, the commission payments may be calculated and paid on an ongoing basis (i.e., monthly, quarterly, etc.). The commission payments may be based at least in part on an initial sign-up of the new member, or they may be based at least in part on a portion of the new member's recurring charges. In embodiments, the commissioning module 1810 deposits the compensation as funds into an account held at one of the third party providers 118 via the third party adaptors 120. The funds in the account may be tied to a debit card issued to the entity. The commissioning module 1810 may be configured to track purchases made by the entities at participating retailers.

A relationship network module of the commissioning module 1810 determines a relationship network associated with an entity, such as relationship networks 500, 600, and 700. The relationship network includes a plurality of network entities and connections between the network entities. A compensation module of the commissioning module 1810 causes the entity to be provided with compensation based at least in part on a number of entity groups within the relationship network, as is described elsewhere within this Detailed Description, such as with reference to FIGS. 5-7.

In embodiments, the entity groups include network entities that have direct connections to common network entities. In alternative embodiments, an entity group is characterized as having a predetermined number of entity groups anywhere within the relationship network, not necessarily with connections to common network entities. In embodiments, an entity group may have 2, 3, 4, 5, or more entities.

The relationship module of the commissioning module 1810 determines a subset of the plurality of network entities that have direct connections to the entity (i.e., “personal connection entities”). The compensation module of the commissioning module 1810 may determine the compensation based at least in part on a first number of entity groups within a personal network portion of the relationship network (i.e., “personal entity groups”) and on a second number of network entity groups within the relationship network (which includes the “personal entity groups”).

As part of the compensation calculation, the compensation module of the commissioning module 1810 determines a compensation tier for the entity based at least in part on the number of entity groups in the relationship network, as is described elsewhere within this Detailed Description, such as with reference to FIGS. 5-7. And the compensation module of the commissioning module 1810 causes the compensation to be provided to the entity based at least in part on the compensation tier. The compensation module of the commissioning module 1810 may also calculate, and cause to be provided, other compensation to be provided to the entity based at least in part on the determined compensation tier and purchases made by network entities within the relationship network, as is described elsewhere within this Detailed Description.

In embodiments, achieving a compensation tier may be based least in part on constraints, such a percent rule and/or a line rule, as is described elsewhere within this Detailed Description. To implement the line rule, the relationship network module of the commissioning module 1810 determines the number of the plurality of network entities with direct connections to the entity, and the compensation module of the commissioning module 1810 determines the compensation tier further based at least in part on whether the number of the plurality of network entities with direct connections to the entity is greater than or equal to a minimum number for the determined compensation tier.

To implement the percent rule, the relationship network module of the commissioning module 1810 determines, for individual ones of a subset of the plurality of network entities with direct connections to the entity (i.e., the personal connection entities), and the relationship network module of the commissioning module 1810 determines corresponding percentages of the plurality of entity groups that connect to the entity via the individual ones of the subset. The compensation module of the commissioning module 1810 calculates and causes compensation to be provided based at least in part on the corresponding percentages, as is described above.

Memory 1802 also includes the motivation platform 126. A notification module 1812 determines one or more notifications regarding a current compensation status of an entity. The notification module 1812 may query the member database 1808 for information regarding a current compensation status of the entity and select a notification type based at least on the current compensation status. For example, a first notification type may be selected when the entity is operating in a first phase of a commissioning model and a second notification type when the entity is operating in a second phase of the commissioning phase.

A current status module 1814 retrieves data from the member database 1808 regarding a current compensation status at least from a profile of the entity such as a number of connections, a number of personal or extended entity groups, an amount of money currently earned, recent entities added to the relationship network, recent changes in compensation status (such as new bonuses earned or new compensation tiers reached), outreach attempts, guestbook signatures, members signed, and so forth. The notification(s) selected by the notification module 1812 may include some or all of the data retrieved from the member database 1808.

A forward projection module 1816 queries the commissioning module 1810 and/or the member database 1808 to determine one or more actions that the entity can take to achieve a new compensation status. For example, the commissioning module 1810 may determine the number of entities that an entity can add to his or her relationship network to achieve a new compensation status, such a new entity group or commissioning tier or band. The forward projection module 1816 may cause the commissioning module 1810 to run one or more commission calculations based on small increases in sales and/or members added to the member's network to determine the actions that the entity can take to achieve a new compensation status. In the same or different embodiments, the forward projection module 1816 may perform a look up operation to the commissioning model to determine the difference between a next-highest compensation status and the member's current compensation status in order to determine the actions needed to achieve the next-highest compensation status.

An identity module 1818 queries the member database 1808 for information about members of the entity's network in order to determine identities of members who are themselves within a certain range of achieving a new compensation status of their own. For example, the identity module 1818 may determine the identities of entities within the relationship network that can achieve a new entity group upon recruiting one more entity into their relationship networks.

The web service 114 provides a commissioning interface, such as the commissioning interfaces 800, 1100, 1200, 1300, 1400, 1500, 1600, and 1700 to a computing device, such as computing devices 402 and the mobile computing device 408. The commissioning interface includes the notification selected by the notification module 1812 and an interactive tool to enable a user of the computing device to initiate an action to achieve a new compensation status, as is described elsewhere within this Detailed Description.

A social network platform 1820 provides a social network feed to be displayed within the commissioning interface. A contact module 1822 enables the entity to manage a list of contacts, social network connections, email addresses, phone numbers, and so forth to facilitate contacting entities to sign up for service.

### Example Operations for Providing Compensation

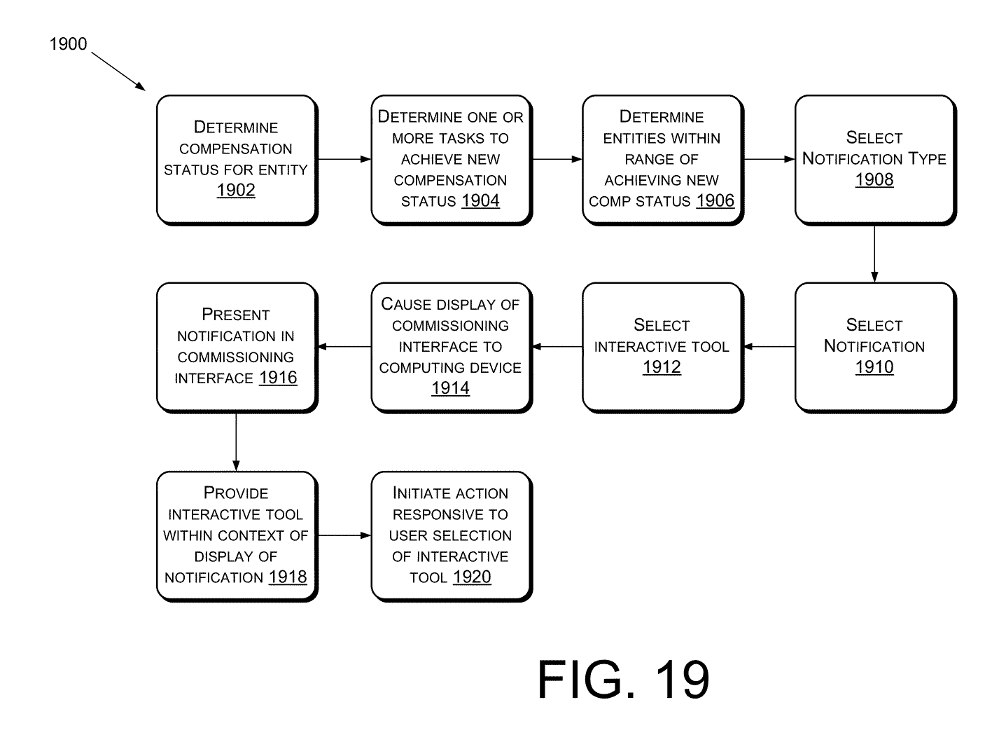

FIG. 19 is a flow diagram showing an example process for providing notifications and interactive tools that enable sales activity. At 1902, a notification module, such as the notification module 1812, determines a compensation status of an entity. This may occur, for example, upon the entity accessing a motivation platform, such as via web service 114 using the computing device 402 or 408. The compensation status is determined by reference to an entity profile and/or a commissioning model, such as the model described herein with reference to FIGS. 5-7 or a different commissioning model.

At 1904, a forward projection module, such as the forward projection module 1816, determines one or more actions that would allow the entity to achieve a new compensation status. The member's profile and/or the commissioning model may be referred to in order to determine the actions that the entity can take to achieve a new compensation status.

At 1906, an identity module, such as the identity module 1818, determines identities of entities within the entity's relationship network that are within a certain range of achieving new compensation statuses of their own. In one example, the identity module references the member profiles and/or the commissioning model to determine those entities that are one entity away from achieving a new entity group. In another example, the identity module references the member profiles and commissioning model to determine those entities that need less than a certain number of entity groups away from achieving a new commissioning tier or band.

At 1908, the notification module selects a notification type based at least on the compensation status of the entity. In one example, a first notification type is selected upon a determination that the entity is operating under a first phase of a commissioning model and a second notification type is selected upon a determination that the entity is operating under a second phase of a commissioning model.

In still other embodiments, the notification module may select the notification type depending on a compensation tier or band achieved by the entity, based on an amount of money earned by the compensation entity, and so forth. In still further embodiments, the notification type is selected based on a determination that there are entities within the relationship network that are within a certain range of achieving new compensation statuses of their own. In other embodiments, the notification type is selected based on the determined one or more tasks that can be completed for the entity to achieve a new compensation status.

At 1910, the notification module selects a notification to be presented on a commissioning interface. The notification may be selected based, e.g., on the selected notification type, the tasks to achieve a new compensation status, identities of entities within the relationship network within a certain range of achieving a new compensation status, and so forth. In various embodiments, information in the notification indicates one or more of an amount of compensation currently earned, a number of entities signed up in a current period, a number of units sold in a current period, a monetary amount of new sales activity, a compensation tier or band currently achieved, or a number of network entities or entity groups within the entity's relationship network. In the same or different embodiments, the information indicates one or more tasks to complete in order to achieve the new compensation status. In the same or different embodiments, the information indicates one or more of a number of new entities to bring into the entity's relationship network to achieve the new compensation status, a number of groups of new entities to bring into the entity's relationship network to achieve a new compensation status, a number of units to sell to achieve a new compensation status, or one or more training activities to achieve the new compensation status. In the same or different embodiments, the notification includes identification of one or more other entities within a relationship network of the entity that are within a certain range of achieving a new compensation status.

At 1912, the notification module selects an interactive tool based at least on the compensation status of the entity. In a first example, the notification module selects tool to invite new members, which enables the entity to message contacts to invite them to join the entity's relationship network, upon a determination that the entity has a relatively small relationship network. The notification module may alternatively select a tool that enables the entity to contact members of the entity's extended or personal network upon a determination that the entity's relationship network is relatively large. The interactive tool may be selected, in various embodiments, based on other factors such as the task or tasks that are determined for the entity to achieve a new compensation status.

At 1914, a web service, such as the web service 114, causes display of a commissioning interface on a computing device of the entity, such as a mobile phone, laptop, desktop, tablet computer, or other device. The commissioning interface includes one or more notification placeholders for the display of notifications. The commissioning interface may also include locations for one or more interactive tools to enable the entity to initiate an action to achieve a new compensation status.

At 1916, the web service presents the selected notification within the commissioning interface, such as within a notification placeholder of the commissioning interface.

At 1918, the web service provides the interactive tool within context of the display of the notification. By displaying the interactive tool within the context of the display of the notification, the commissioning interface reduces the effort required on behalf of the entity to act on the information regarding their compensation status and to initiate actions to achieve a new compensation status.

At 1920, an action is initiated responsive to user selection of the interactive tool. In embodiments, the action includes one or more of posting a message to a entity's social networking account, inviting a new entity to join the entity's relationship network, messaging one or more other entities within the entity's relationship network, initiating a telephonic or video call, sending one or more messages with information or links to information about joining a service, initiating an SMS message, and so forth.

FIG. 19 depicts a flow graph that shows example processes in accordance with various embodiments. The operations of these processes are illustrated in individual blocks and summarized with reference to those blocks. These processes are illustrated as a logical flow graph, each operation of which may represent a set of operations that can be implemented in hardware, software, or a combination thereof. In the context of software, the operations represent computer-executable instructions stored on one or more computer storage media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be combined in any order, separated into sub-operations, and/or performed in parallel to implement the process. Processes according to various embodiments of the present disclosure may include only some or all of the operations depicted in the logical flow graph.

### Computer-Readable Media

Depending on the configuration and type of computing device used, memory 1802 may include volatile memory (such as random access memory (RAM)) and/or non-volatile memory (such as read-only memory (ROM), flash memory, etc.). Memory 1802 may also include additional removable storage and/or non-removable storage including, but not limited to, flash memory, magnetic storage, optical storage, and/or tape storage that may provide non-volatile storage of computer-readable instructions, data structures, program modules, and other data for mobile device 104 or transaction service 108.

Memory 1802 is an example of computer-readable media. Computer-readable media includes at least two types of computer-readable media, namely computer storage media and communications media.

Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer-readable instructions, data structures, program modules, or other data in a modulated data signal, such as a carrier wave, or other transmission mechanism. As defined herein, computer storage media does not include communication media.

### CONCLUSION

Although the disclosure uses language that is specific to structural features and/or methodological acts, the invention is not limited to the specific features or acts described. Rather, the specific features and acts are disclosed as illustrative forms of implementing the invention.

1. A method of enabling sales activity, comprising:
determining a task to be completed for an entity to achieve a new compensation status;
causing display of a commissioning interface on a computing device;
presenting within the commissioning interface a notification regarding the task to be completed for the entity to achieve the new compensation status; and
providing an interactive tool within a context of the display of the notification, the interactive tool to enable the entity to initiate the task to be completed to achieve the new compensation status.

2. The method of claim 1, further comprising selecting the notification based at least on a current compensation status of the entity.

3. The method of claim 2, wherein the notification is selected based at least on a commissioning phase of the entity indicated by the current compensation status.

4. The method of claim 1, wherein the notification indicates one or more of an amount of compensation currently earned, a number of entities signed up in a current period, a number of units sold in a current period, a monetary amount of new sales activity, a compensation tier or band currently achieved, or a number of network entities within the entity's relationship network.

5. (canceled)

6. The method of claim 1, wherein the task includes one or more of a number of new entities to bring into the entity's relationship network to achieve the new compensation status, a number of units to sell to achieve the new compensation status, or one or more training activities to achieve the new compensation status.

7. The method of claim 1, wherein the notification includes identification of one or more other entities within a relationship network of the entity that are within a certain range of achieving a new compensation status of their own.

8. The method of claim 7, wherein the range is one new entity to achieve an additional entity group.

9. The method of claim 1, wherein the interactive tool enables the entity to one or more of post a message to a entity's social networking account, invite a new entity to join the entity's relationship network, message one or more other entities within the entity's relationship network, initiate a telephonic or video call, or send one or more messages with information or links to information about joining a service.

10. (canceled)

11. The method of claim 1, wherein the new compensation status is determined based at least in part on a profile of the entity and a commissioning model.

12. The method of claim 1, further comprising determining the task to be completed for the entity to achieve the new compensation status based at least on reference to an entity profile and a commissioning model.

13. The method of claim 1, wherein the computing device is a mobile computing device.

14. The method of claim 1, wherein the sales activity is associated with one or more of a mobile telephone service, an energy service, a television service, or an internet service.

15. One or more computer memories including a plurality of instructions that is executable by one or more processors to:
provide a commissioning interface to be displayed on a display of a computing device, the commissioning interface including a notification regarding one or more tasks to be completed for an entity to achieve a new compensation status;
select an interactive tool to be displayed within a context of the display of the notification, the interactive tool selected to enable the entity to initiate the one or more tasks to achieve the new compensation status;
cause the display of the interactive tool within the context of the display of the notification within the commissioning interface, such that the notification and the selected interactive tool are simultaneously visible; and
initiate the action responsive to selection of the interactive tool.

16. The one or more computer memories of claim 15, wherein the instructions are further executable to select the notification based at least on a current compensation status of the entity.

17. The one or more computer memories of claim 15, wherein the instructions are further executable to select the notification based at least on a commissioning phase of the entity.

18. The one or more computer memories of claim 15, wherein the instructions are further executable to select the interactive tool based on at least a current compensation status.

19. The one or more computer memories of claim 15, wherein the notification indicates a number of entity groups within the entity's relationship network.

20. (canceled)

21. The one or more computer memories of claim 15, wherein the notification includes identification of one or more other entities within the entity's relationship network that are within a certain range of achieving a new compensation status of their own.

22. A system for enabling sales activity, comprising:
one or more processors;
memory;
a notification module stored on the memory and executable by the one or more processors to determine a notification regarding one or more tasks for an entity to complete in order for the entity to achieve a new compensation status; and
a web module stored on the memory and executable by the one or more processors to provide a commissioning interface to a computing device to be displayed on a display of the computing device, the commissioning interface including the notification and an interactive tool, the interactive tool selected based on the one or more tasks to enable a user of the computing device to initiate the one or more tasks to achieve the new compensation status.

23. The system of claim 22, wherein the notification includes data regarding a current compensation status of the entity, and wherein the system further comprises a current status module stored on the memory and executable by the one or more processors to retrieve the data regarding current compensation status at least from a profile of the entity.

24. The system of claim 22, wherein the system further comprises a forward projection module stored on the memory and executable by the one or more processors to determine the one or more tasks to achieve the new compensation status based at least on a profile of the entity and a commissioning model associated with the sales activity.

25. The system of claim 22, wherein the notification indicates an identity of another entity, within a relationship network of the entity, that is within a certain range of obtaining a new compensation status of their own.

26. The method of claim 1, wherein the task includes a number of groups of two or more new entities to bring into the entity's relationship network to achieve the new compensation status.

27. The method of claim 1, wherein:
the determining the task to be completed to achieve the new compensation status includes determining from the existing network an identity of a network entity, within an existing network of the entity, that requires only one additional entity to achieve a new entity group, an entity group including two or more entities with direct connections to a same entity; and
the method further comprises selecting the interactive tool based at least on the identity of the network entity that requires only one additional entity to achieve a new entity group.

28. The method of claim 1, wherein:
the determining the task to be completed to achieve the new compensation status includes determining from the existing network an identity of a network entity, within an existing network of the entity, that requires only one additional entity to achieve a new entity group, an entity group including two or more entities with direct connections to a same entity; and
the method further comprises selecting the notification based at least on the identity of the network entity that requires only one additional entity to achieve a new entity group.

29. The method of claim 1, wherein:
the determining the task to be completed to achieve the new compensation status includes determining from the existing network an identity of a network entity, within an existing network of the entity, that requires only one additional entity to achieve a new entity group, an entity group including two or more entities with direct connections to a same entity; and
the method further comprises selecting both the interactive tool and the notification based at least on the identity of the network entity that requires only one additional entity to achieve a new entity group.
